(19) United States
(12) Patent Application Publication
(10) Pub. No.: US 2023/0385747 A1
(43) Pub. Date: Nov. 30, 2023

(54) INFORMATION PROCESSING SYSTEM AND METHOD FOR PROCESSING INFORMATION

(71) Applicant: FRONTEO, Inc., Tokyo (JP)

(72) Inventors: Toru HISAMITSU, Tokyo (JP); Yuichi KICHIKAWA, Tokyo (JP)

(21) Appl. No.: 18/295,607

(22) Filed: Apr. 4, 2023

(30) Foreign Application Priority Data
May 30, 2022 (JP) 2022-088060

(51) Int. Cl. G06Q 10/08; G06Q 10/067

(52) U.S. Cl. CPC G06Q 10/08; G06Q 10/067; G06Q 10/06395

(57) ABSTRACT

An information processing system includes: a supply chain network obtaining unit obtaining a supply chain network in which a plurality of nodes, each corresponding to one of a plurality of companies, are connected together with links; a subnetwork extracting unit extracting, from the supply chain network, a subnetwork including at least one of an upstream subnetwork including an upstream company supplying a first company with a product, or a downstream subnetwork including a downstream company supplied with the product from the first company; a path extracting unit extracting a path group including one or more paths in the subnetwork, the one or more paths connecting a node representing the first company and a node representing a second company with one or more of the links; and a redrawing unit redrawing the path group extracted by the path extracting unit.

### CROSS-REFERENCE TO RELATED APPLICATION

The present application claims priority from Japanese Application JP2022-088060 filed on May 30, 2022, the content to which is hereby incorporated by reference into this application.

### BACKGROUND OF THE INVENTION

### 1. Field of the Invention

The present invention relates to, for example, an information processing system and a method for processing information.

### 2. Description of the Related Art

Various conventional techniques are known for supply chain analysis. A supply chain refers to a series of activities from procurement of raw materials and components of a product to manufacture, inventory management, delivery, sale, and consumption of the product. For example, JP7034447B1 discloses an information processing system to analyze, for a supply chain, a subnetwork including at least one of an upstream subnetwork or a downstream subnetwork of a company of interest, and to display a result of the analysis. Moreover, for example, a press release “FRONTEO patented for a technique to provide an AI-based economic security solution ‘supply chain analysis service’” by PR TIMES discloses that if connection to a specific company in a supply chain network is visualized, the user can check whether the user's supply chain possibly includes a predetermined company.

### SUMMARY OF THE INVENTION

However, conventionally known supply chain analysis techniques have some problems. For example, the information processing system of JP7034447B1 would display a path including a company referred to as a platform company trading with many companies. However, the path including the platform company is not necessarily a path to form an actual supply chain. Hence, the supply chain displayed on the information processing system might not necessarily be the actual one.

Moreover, the information processing system of JP7034447B1 creates a supply chain in accordance with open information. Hence, the information processing system of JP7034447B1 fails to reflect, in the supply chain, a company not included in the open information.

Furthermore, because the information processing system of JP7034447B1 displays a path in a supply chain, it is not easy to find a path as a substitute for the specific path in the supply chain, on the assumption that, for example, a user of the information processing system cannot use a specific path.

Aspects of the present disclosure are intended to provide information processing system and a method for processing information capable of redrawing an extracted path.

An aspect of the present disclosure relates to an information processing system The information processing system includes: a supply chain network obtaining unit obtaining a supply chain network in which a plurality of nodes, each corresponding to one of a plurality of companies, are connected together with links each representing a trading relationship that associates a supply source company of a product with a supply destination company of the product; a subnetwork extracting unit extracting, from the supply chain network, a subnetwork including at least one of an upstream subnetwork including an upstream company supplying a first company with the product, or a downstream subnetwork including a downstream company supplied with the product from the first company, the first company, the upstream company, and the downstream company being included in the plurality of companies; a path extracting unit extracting a path group including one or more paths in the subnetwork, the one or more paths connecting a node representing the first company and a node representing a second company with one or more of the links, and the second company being different from the first company; and a redrawing unit redrawing the path group extracted by the path extracting unit.

Another aspect of the present disclosure relates to a method for processing information executed by an information processing system. The method includes: obtaining a supply chain network in which a plurality of nodes, each corresponding to one of a plurality of companies, are connected together with links each representing a trading relationship that associates a supply source company of a product with a supply destination company of the product; extracting, from the supply chain network, a subnetwork including at least one of an upstream subnetwork including an upstream company supplying a first company with the product, or a downstream subnetwork including a downstream company supplied with the product from the first company, the first company, the upstream company, and the downstream company being included in the plurality of companies; extracting a path group including one or more paths in the subnetwork, the one or more paths connecting a node representing the first company and a node representing a second company with one or more of the links, and the second company being different from the first company; and redrawing the extracted path group.

### BRIEF DESCRIPTION OF THE DRAWINGS

FIG. 1 illustrates an example of a configuration of a system including an information processing system according to an embodiment;

FIG. 2 is a functional block diagram illustrating an example of a detailed configuration of a server system in FIG. 1;

FIG. 3 is a functional block diagram illustrating an example of a detailed configuration of a terminal device in FIG. 1;

FIG. 4 is a flowchart schematically showing processing to be executed on the information processing system in FIG. 1;

FIG. 5A shows an exemplary configuration of data to be obtained in accordance with open information;

FIG. 5B shows an exemplary configuration of data to be obtained in accordance with the open information;

FIG. 5C is a graph partially illustrating an example of a supply chain network to be obtained in accordance with the open information;

FIG. 6 is a graph schematically illustrating the supply chain network;

FIG. 7 is a flowchart showing processing to extract an upstream subnetwork;

FIG. 8A is a graph partially illustrating an example of a subnetwork;

FIG. 8B is a graph partially illustrating an example of the subnetwork;

FIG. 9 is a graph illustrating an example of the subnetwork;

FIG. 10 is a graph schematically illustrating how to extract a path group;

FIG. 11 is a graph schematically illustrating an operation input to delete a specific node;

FIG. 12 is a graph schematically illustrating a result of redrawing in delete processing;

FIG. 13 is a graph schematically illustrating another example of the delete processing;

FIG. 14 is a graph schematically illustrating a result of redrawing in another example of the delete processing;

FIG. 15 is a view illustrating an example of an input screen for designating an industrial classification to be deleted;

FIG. 16 is a flowchart showing the delete processing executed when a node to be deleted is identified with the industrial classification;

FIG. 17 is a graph schematically illustrating a result of redrawing executed in the delete processing when a node to be deleted is designated with the industrial classification;

FIG. 18 is a graph schematically illustrating node adding processing;

FIG. 19 is a graph schematically illustrating an operation input to add a new node;

FIG. 20 is a flowchart showing the node adding processing;

FIG. 21A illustrates an example of a local graph;

FIG. 21B illustrates an example of a local graph;

FIG. 22A illustrates an example of a virtual local graph;

FIG. 22B illustrates an example of a virtual local graph;

FIG. 23 illustrates an example of an existing local graph;

FIG. 24 is a table showing the kinds and number of transition types;

FIG. 25 is a graph illustrating a display example of companies for a candidate node connected to an additional node with a link;

FIG. 26 is a graph schematically illustrating a result of redrawing in the node adding processing;

FIG. 27 is a graph schematically illustrating substitute path calculating processing;

FIG. 28 is a flowchart showing the substitute path calculating processing; and

FIG. 29 is a graph schematically illustrating a result of redrawing in the substitute path calculating processing.

### DETAILED DESCRIPTION OF THE INVENTION

The following descriptions are an embodiment with reference to the drawings. Identical reference signs are used to denote identical or substantially identical constituent elements between the drawings. If the descriptions of such elements are redundant, the redundant descriptions will be omitted as appropriate. Note that the embodiment described below shall not limit the descriptions recited in claims. Moreover, not all of the configurations described in the embodiment are necessarily essential features of the present disclosure. As long as the functions to be described in the present disclosure are carried out, the configurations to be described in the embodiment may be omitted as appropriate.

### 1. Example of System Configuration

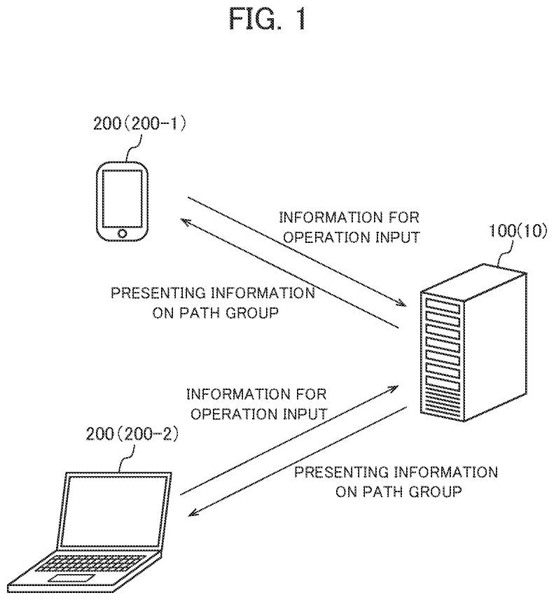

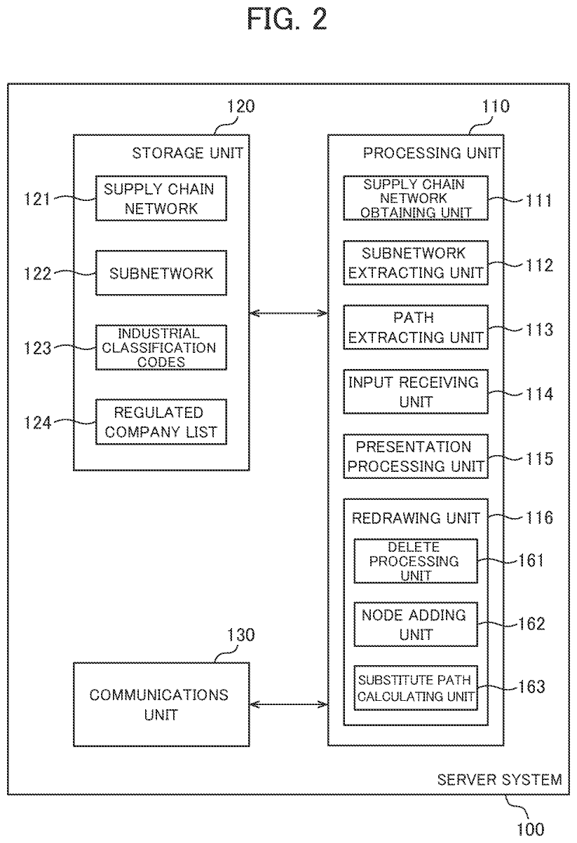

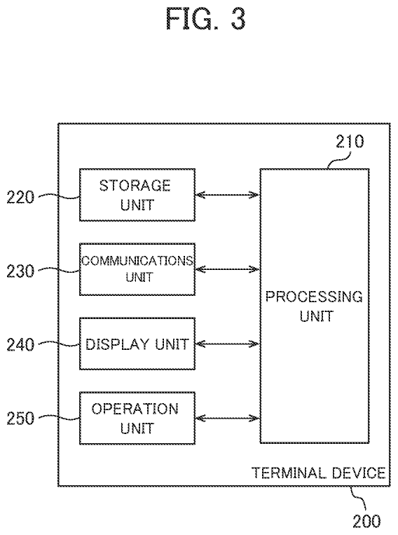

FIG. 1 is an example of a configuration of a system including an information processing system 10 according to an embodiment. The system according to this embodiment includes: a server system 100; and a terminal device 200. Note that the configuration of the system including the information processing system 10 shall not be limited to the configuration in FIG. 1. The system can be modified in various manners such that, for example, a part of the configuration may be omitted, or another constituent element may be additionally included. For example, in FIG. 1, the terminal device 200 includes two terminal devices 200-1 and 200-2. However, the number of the devices 200 shall not be limited to two. Moreover, the same applies to FIGS. 2 and 3 to be shown later, regarding modifications such as omission and addition of constituent elements.

The information processing system 10 of this embodiment corresponds to, for example, the server system 100. Note that the configuration of this embodiment shall not be limited to this example. The processing on the information processing system 10 described in this Specification may be executed by distributed processing, using the server system 100 and another device. For example, the information processing system 10 of this embodiment may be implemented by distributed processing on the server system 100 and the terminal device 200. This Specification describes below an example in which the information processing system 10 is the server system 100.

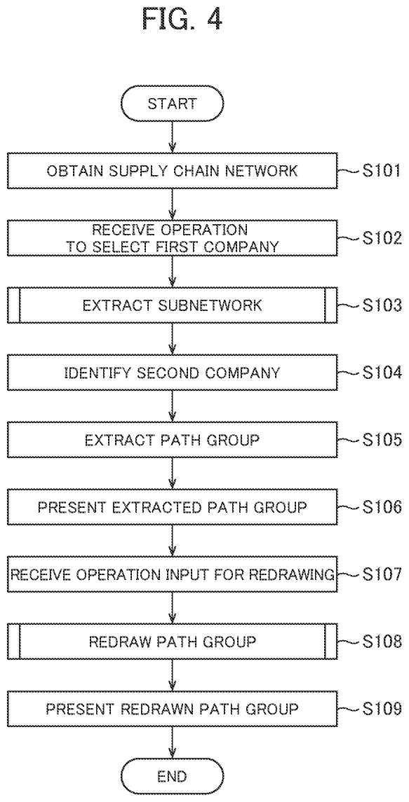

The server system 100 may include either a single server or a plurality of servers. For example, the server system 100 may include a database server and an application server. The database server stores various kinds of data including a supply chain network 121 to be described later. The application server executes processing to be described later with reference to, for example, FIGS. 4, 7, 16, 20, and 28. Note that the plurality of servers here may be either physical servers or virtual servers. Moreover, if the virtual servers are used, the virtual servers may be either provided to one physical server, or distributed among a plurality of physical servers. As can be seen, a specific configuration of the server system 100 according to this embodiment can be modified in various manners.

The terminal device 200 is used by a user of the information processing system 10. The terminal device 200 may be a personal computer (PC), a mobile terminal device such as a smartphone, or any other like device having a function to be described in this Specification.

The server system 100 is communicably connected to the terminal device 200-1 and the terminal device 200-2, for example, over a network. Hereinafter, the terminal device 200-1 and the terminal device 200-2 will simply be referred to as the terminal device 200 unless the terminal devices have to be distinguished from each other. The network here is, for example, a public communications network such as the Internet. Alternatively, the network may also be a local area network (LAN).

The information processing system 10 of this embodiment is an open source intelligence (OSINT) system for, for example, collecting and analyzing data related to a target, using, for example, open information. Here, the open information includes various kinds of information widely accessible and legally available. Examples of the open information may include securities reports, inter-industry relations tables, official announcements of the government, news reports on countries and companies, and supply chain databases. Moreover, the open information may include various kinds of information transmitted and received via the social networking service (SNS). For example, the SNS may include services with which users can post, for example, text and images. The open information in this embodiment may include the text, the images, or results of, for example, natural language processing or image processing of the text and the images.

The server system 100 generates nodes including various attributes on the basis of open information. One node represents a given entity. Here, the entity is a company. Attributes of a node are various kinds of information determined on the basis of open information. The attributes include the name, the nationality, the business field, the industrial classification, a trading partner, and trading goods of the company. IF a node representing an entity is a company, the node is provided with attributes related to the company, including the industrial classification of the company. Note that the attributes here may include for example, sales, the number of employees, shareholders and their capital contribution ratios, and board members. In this embodiment, among the attributes, at least an industrial classification is provided to the node. The industrial classification is a kind of an industry classified by a characteristic of the industry. In classifying the industries, for example, industrial classification codes may be used. The industrial classification codes are information to classify the industries into several fields, and a code, such as “01”, is assigned to each of the classification results.

If the attributes of a given node include an attribute including a relationship with another node, the given node and the other node are connected together with a link having a direction. For example, suppose a given company is intended to provide (sell) a trading product of some sort to another company. In this case, a node corresponding to the other company and a node corresponding to the given company are connected together with a link representing a buy-sell relationship (distribution relationship) of the product. Here, the link has a direction from an influencing entity to an influenced entity; that is, for example, from a seller to a buyer of a product of some sort. That is, the link represents a trading relationship that associates a supply source company of a product with a supply destination company of the product.

In accordance with the technique of this embodiment, the server system 100 obtains an entity network; that is, a network in which a plurality of nodes representing a plurality of entities (e.g., companies) are connected together with a plurality of links representing trading relationships. Because the links have directions, the entity network is a directed graph. The server system 100 conducts an analysis based on the entity network, and executes processing to present results of the analysis. For example, the terminal device 200 is a device used by a user of a service provided by an OSINT system. For example, the user uses the terminal device 200 to send a request to the server system 100; that is, the information processing system 10, to conduct an analysis of some sort. The server system 100 conducts an analysis based on the entity network, and transmits the results of the analysis to the terminal device 200. The entity network in this embodiment is, in a narrow sense of the term, the supply chain network 121 representing a supply chain. Hereinafter, in this embodiment, the entity network is the supply chain network 121.

FIG. 2 is a functional block diagram illustrating an example of a detailed configuration of the server system 100. The server system 100 includes, as illustrated in FIG. 2, for example, a processing unit 110, a storage unit 120, and a communications unit 130.

The processing unit 110 of this embodiment includes hardware below. The hardware can include at least one of a digital signal processing circuit or an analogue signal processing circuit. For example, the hardware can include one or a plurality of circuit devices mounted on a circuit board, and one or a plurality of circuit elements. The one or the plurality of circuit devices are, for example, integrated circuits (ICs) or field-programmable gate arrays (FPGAs). The one or plurality of circuit elements are, for example, resistors or capacitors.

The processing unit 110 may be provided in a form of the processor below. The server system 100 of this embodiment includes: a memory that stores information; and a processor that operates on the information stored in the memory. The information includes, for example, a program and various kinds of data. The program may include a program to cause the server system 100 to execute the processing described in this Specification. The processor includes hardware. The processor can include various kinds of processors such as, for example, a central processing unit (CPU), a graphics processing unit (GPU), and a digital signal processor (DSP). The memory may be: a semiconductor memory such as a static random access memory (SRAM), a dynamic random access memory (DRAM), or a flash memory; a resistor; a magnetic storage device such as a hard disk drive (HDD); or an optical storage device such as an optical disc drive. For example, the memory holds a computer-readable instruction. When the processor executes the instruction, a function of the processing unit 110 is carried out in the form of processing. Here, the instruction may be a set of instructions included in the program, or an instruction for instructing a hardware circuit of the processor to operate.

The processing unit 110 includes, for example: a supply chain network obtaining unit 111; a subnetwork extracting unit 112; a path extracting unit 113; an input receiving unit 114; a presentation processing unit 115; and a redrawing unit 116.

The supply chain network obtaining unit 111 obtains the supply chain network 121. For example, the supply chain network obtaining unit 111 may generate, to obtain, the supply chain network 121 in accordance with open information. The open information includes trading relationship information that associates a supply source company of a product with a supply destination company of the product. The supply chain network obtaining unit 111 stores the generated supply chain network 121 in the storage unit 120. Note that the supply chain network 121 may be generated by a system different from the information processing system 10 according to this embodiment. In such a case, the supply chain network obtaining unit 111 may execute processing to obtain the generated result from the different system.

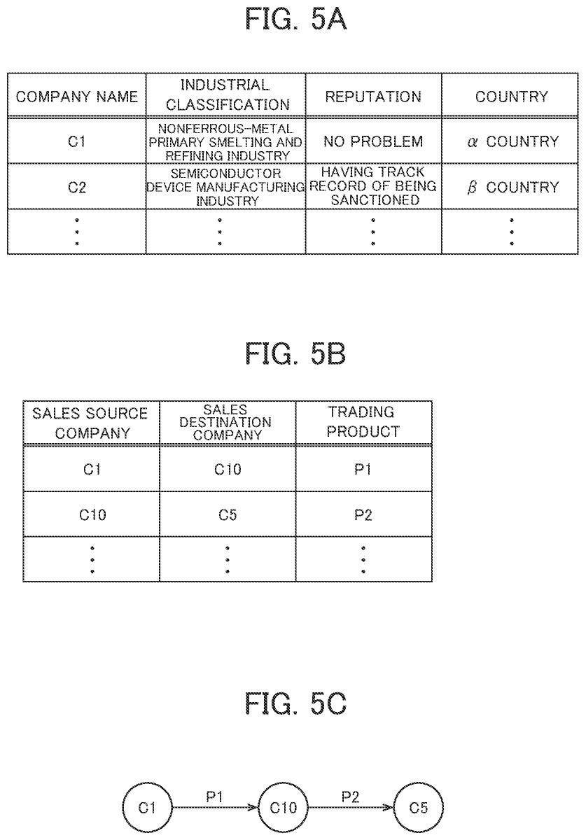

As will be described later with reference to, for example, FIGS. 5A to 5C, the supply chain network obtaining unit 111 may obtain a network as the supply chain network 121, in accordance with the trading relationships between the companies. In the network, a plurality of nodes corresponding to a plurality of companies are connected together.

The subnetwork extracting unit 112 executes processing to extract, as the subnetwork 122, a portion of the supply chain network 121 obtained by the supply chain network obtaining unit 111. The subnetwork 122 is a directed graph. For example, in the supply chain network 121, the subnetwork 122 includes a node group directly or indirectly connected to a node representing a specific company.

Here, the specific company is one of a plurality of companies represented by nodes included in the supply chain network 121. The specific company is, for example, a company acting as a reference for analysis conducted on the information processing system 10. The specific company may be selected by, for example, the user of the information processing system 10 carrying out a predetermined operation input. Hereinafter, in this Specification, the specific company is also referred to as a “first company”.

The subnetwork extracting unit 112 extracts the subnetwork 122 included in the supply chain network 121 and related to the first company. The subnetwork 122 here includes at least one of an upstream subnetwork including an upstream company supplying the first company with a product, or a downstream subnetwork including a downstream company supplied with the product from the first company. In this Specification, the term upstream means a start of a link; that is, a provider of a commodity to another company. The term downstream means an end of a link; that is, a receiver of a commodity from another company. The upstream company includes a company that directly provides a commodity to the first company. Note that the upstream company in this Specification may include a company positioned upstream of another upstream company. That is, the upstream company may include a company connected to the first company through another company. The same applies to the downstream company. The downstream company may include a company that directly receive a commodity from the first company, and a company positioned downstream of another downstream company.

The subnetwork extracting unit 112 may store the extracted subnetwork 122 in the storage unit 120.

The path extracting unit 113 extracts a path group including one or more paths in the subnetwork 122 extracted by the subnetwork extracting unit 112. Here, each path is a route from one node to another node through one or more links. That is, the path is a route connecting one node and another node through one or more links.

In this embodiment, the path extracting unit 113 extracts a path group. The path group includes one or more paths connecting a node representing the first company and a node representing a second company with one or more links. The second company is one of the plurality of companies represented by the nodes included in the supply chain network 121. The second company is different from the first company. The second company may be designated by, for example, the user carrying out a predetermined operation input to the input receiving unit 114. Alternatively, as to the second company, in accordance with a designated condition received by the input receiving unit 114, the path extracting unit 113 may automatically determine, as the second company, a company matching the designated condition. The second company may be, for example, a regulated company whose trading is regulated. More specifically, the second company may have a problem in view of environment, social, and governance (ESG). Alternatively, the second company may be a company corresponding to a chokepoint in the subnetwork 122.

The path extracting unit 113 can extract a path, satisfying a specific condition, from among paths connecting a node representing the first company and a node representing the second company with one or more links, and determine the extracted path as a path group. The specific condition may be determined as appropriate. The specific condition may be, for example, the shortest path. If the specific condition is the shortest path, the path extracting unit 113 extracts a path, having the fewest links to travel through, from among the paths connecting the node representing the first company and the node representing the second company with one or more of the links. The specific condition may be determined by, for example, an operation input carried out by the user. In this Specification described below, the specific condition is the shortest path.

The input receiving unit 114 performs processing to receive an operation input carried out by the user using the information processing system 10. For example, the input receiving unit 114 can receive the operation input carried out by the user as follows: when the user carries out the operation input on an operation unit 250 of the terminal device 200, the input receiving unit 114 receives an operation signal of the operation input from the terminal device 200 through the communications unit 130. Alternatively, the input receiving unit 114 may receive the operation input carried out by the user on a not-shown operation unit (an input interface) included in the information processing system 10.

Here, the operation input includes an operation to select the first company. The operation input may also include an operation to select the second company. The operation input may include an input of a condition for the path extracting unit 113 to determine the second company. Moreover, in this embodiment, the operation input includes an operation input for redrawing a path. The operation input for redrawing a path will be described later in detail.

The presentation processing unit 115 performs processing to present, to the user, the path group extracted by the path extracting unit 113. In this embodiment, the presentation processing unit 115 further performs processing to present, to the user, a path group redrawn by the redrawing unit 116. For example, the presentation processing unit 115 performs processing to display a display screen. The display screen is a screen to be displayed on, for example, a display unit 240 of the terminal device 200. For example, the presentation processing unit 115 performs processing to generate the display screen and transmit the display screen to the terminal device 200 through the communications unit 130. Moreover, the processing shall not be limited to transmission of the display screen per se. The presentation processing unit 115 may perform processing to transmit information (e.g., markup language) capable of generating the display screen. Note that the display screen may be displayed on a device other than the terminal device 200 of, for example, the server system 100. Moreover, the presentation processing performed by presentation processing unit 115 shall not be limited to display processing. The presentation processing may include an output processing, using such a means as sound.

The redrawing unit 116 redraws the path group extracted by the path extracting unit 113. The redrawing unit 116 redraws the path group in accordance with, for example, the operation input received by the input receiving unit 114 for redrawing the path. In this embodiment, the redrawing unit 116 includes: a delete processing unit 161; a node adding unit 162; and a substitute path calculating unit 163. Note that the redrawing unit 116 does not necessarily have to include all of the delete processing unit 161, the node adding unit 162, and the substitute path calculating unit 163. The redrawing unit 116 may include at least one of these units.

The delete processing unit 161 executes delete processing to delete a specific node of the path extracted by the path extracting unit 113. The node adding unit 162 executes node adding processing to add a node of a new company to the path group extracted by the path extracting unit 113. The substitute path calculating unit 163 executes substitute path calculating processing to calculate a substitute path similar to a path included in the path group extracted by the path extracting unit 113. The delete processing, the node adding processing, and the substitute path calculating processing will be described later in detail.

The storage unit 120 is a working area of the processing unit 110, and stores various kinds of information. The storage unit 120 may be provided in the form of various kinds of memories. The memories may include: a semiconductor memory such as an SRAM, a DRAM, a ROM, and a flash memory; a resistor; a magnetic storage device such as a hard disk drive; and an optical storage device such as an optical disc drive.

The storage unit 120 stores, for example, the supply chain network 121 obtained by the supply chain network obtaining unit 111. Moreover, the storage unit 120 stores, for example, the subnetwork 122 extracted by the subnetwork extracting unit 112. Furthermore, the storage unit 120 may store open information such as securities reports and inter-industry relations tables. In addition, the storage unit 120 may store, for example, industrial classification codes 123 and a regulated company list 124. The industrial classification codes 123 are information to classify the industries into several fields, and a code, such as “01”, is assigned to each of the classification results. The regulated company list 124 is information to identify a company having a problem in view of, for example, the ESG. Otherwise, the storage unit 120 can store various information on the processing performed in this embodiment.

The communications unit 130 is an interface for performing communications through a network, and includes, for example, an antenna, a radio frequency (RF) circuit, and a baseband circuit. The communications unit 130 may operate by the control of the processing unit 110, and may include a communications controlling processor different from the processing unit 110. The communications unit 130 is an interface for performing communications in accordance with, for example, the transmission control protocol/Internet protocol (TCP/IP). Note that the specific communications scheme can be modified in various manners.

FIG. 3 is a block diagram illustrating an example of a detailed configuration of the terminal device 200. The terminal device 200 includes: a processing unit 210, a storage unit 220, a communications unit 230, the display unit 240, and the operation unit 250.

The processing unit 210 is hardware including at least one of a digital signal processing circuit or an analog signal processing circuit. Moreover, the processing unit 210 may be provided in the form of a processor. The processor may include various kinds of processors such as a CPU, a GPU, and a DSP. The processor executes an instruction stored in the memory of the terminal device 200, so that a function of the processing unit 210 is carried out in the form of processing.

The storage unit 220 is a working area of the processing unit 210, and is provided in the form of various kinds of memories such as an SRAM, a DRAM, and a ROM.

The communications unit 230 is an interface for performing communications through a network, and includes, for example, an antenna, an RF circuit, and a baseband circuit. The communications unit 230 performs communications with the server system 100 through, for example, a network.

The display unit 240 is an interface to display various kinds of information, and may be a liquid crystal display, an organic EL display, or a display that operates under any other scheme. The operation unit 250 is an interface to receive an operation input by the user. The operation unit 250 may be, for example, a button provided to the terminal device 200. Moreover, the display unit 240 and the operation unit 250 may be combined to form a touch panel.

### 2. Flow of Processing

### 2.1 Overview of Flow

FIG. 4 is a flowchart schematically showing processing to be executed on the information processing system 10 of this embodiment.

First, at Step S101, the supply chain network obtaining unit 111 obtains the supply chain network 121. The supply chain network obtaining unit 111 stores the supply chain network 121 in the storage unit 120.

At Step S102, the input receiving unit 114 receives an operation input carried out by the user. Here, the operation input is an operation to select the first company. The operation input carried out by the user may be executed on, for example, the operation unit 250 of the terminal device 200. In such a case, the input receiving unit 114 obtains, through, for example, the communications unit 130, an operation signal indicating the operation input executed on the terminal device 200. Alternatively, the server system 100 may include a not-shown operation unit, and the input receiving unit 114 may receive an operation input executed using the operation unit. Otherwise, specific aspects of receiving the operation input can be modified in various manners.

At Step S103, the subnetwork extracting unit 112 extracts the subnetwork 122.

At Step S104, the path extracting unit 113 identifies the second company. The path extracting unit 113 can identify the second company, for example, as follows: the input receiving unit 114 receives from the user a selection operation to select the second company, and, in accordance with the received selection operation, the path extracting unit 113 identifies the second company. In accordance with a designated condition received by the input receiving unit 114, the path extracting unit 113 may determine, as the second company, a company that matches the designated condition.

At Step S105, the path extracting unit 113 extracts a path group including one or more paths connecting a node representing the first company and a node representing the second company with one or more links. Here, the path extracting unit 113 extracts a path group including the shortest path as a specific condition.

At Step S106, the presentation processing unit 115 performs processing to present the extracted path group. For example, the presentation processing unit 115 performs processing to generate a display screen including the extracted path group, and to transmit the display screen to the terminal device 200 through the communications unit 130. The terminal device 200 displays the received display screen on the display unit 240. With reference to the screen displayed on the display unit 240, the user can check the extracted path group.

If the user desires to redraw the path group displayed on the display unit 240, the user carries out an operation input for redrawing, using, for example, the operation unit 250 of the terminal device 200.

At Step S107, the input receiving unit 114 receives the operation input for redrawing carried out by the user. For example, through the communications unit 130, the input receiving unit 114 obtains an operation signal, which indicates the operation input executed on the operation unit 250 of the terminal device 200, to receive the operation input for the redrawing.

At Step S108, the redrawing unit 116 redraws the path group in accordance with the operation input for redrawing received by the input receiving unit 114. Specifically, in accordance with the operation input for the redrawing, the redrawing unit 116 executes the delete processing, the node adding processing, or the substitute path calculating processing.

At Step S109, the presentation processing unit 115 performs processing to present the redrawn path group. For example, the presentation processing unit 115 performs processing to generate a display screen including the redrawn path group, and to transmit the display screen to the terminal device 200 through the communications unit 130. The terminal device 200 displays the received display screen on the display unit 240. With reference to the screen displayed on the display unit 240, the user can check the redrawn path group.

### 2.2 Obtaining Supply Chain Network

Described below is processing to obtain the supply chain network 121, which corresponds to Step S101 in FIG. 4. The supply chain network obtaining unit 111 may generate the supply chain network 121 in accordance with open information. The open information includes, for example, such information as securities reports and press releases.

The supply chain network obtaining unit 111 identifies various information such as the name, the nationality, a trading partner, and trading goods of a company, for each of many companies. Moreover, the supply chain network obtaining unit 111 may identify the number of employees, shareholders and their capital contribution ratio, and board members of each company, in accordance with the open information.

Moreover, the supply chain network obtaining unit 111 may obtain reputation information indicating reputation of each company, in accordance with the open information. For example, the reputation information is information indicating, for example, whether a target company has a problem, or a track record of being sanctioned, in view of environment, social, and governance (ESG). For example, the reputation information may be information indicating that the target company is a company violated export regulations, a company handling conflict minerals, a company involved in slave labor, or a company involved in illegal logging. Moreover, the open information may be a document issued by, for example, a government institute, and the reputation information may be information indicating whether the target company is subjected to restriction on trade with, for example, a predetermined country. Furthermore, as described above, the open information may include information on the SNS. The reputation information here may be information determined in accordance with the SNS. For example, the supply chain network obtaining unit 111 may obtain the reputation information in accordance with information sent via, for example, a company official account on the SNS. In addition, the SNS information to be used for the technique of this embodiment shall not be limited to information sent from an official account. For example, on the SNS, if the predetermined number or more of users are sending a given company name along with such words as “conflict minerals”, “slave labor”, and “illegal logging”, the given company may be associated with negative reputation information.

FIGS. 5A and 5B show exemplary configurations of data to be obtained in accordance with the open information. As illustrated in FIG. 5A, the supply chain network obtaining unit 111 obtains information in which each of the companies included in the open information is associated with a company name, an industrial classification, a reputation, and a nationality.

The company name is text data indicating, for example, the name of a target company. The industrial classification is information indicating a business field of a target company. The reputation is, as described above, information indicating whether a target company has a problem in view of the ESG. The nationality is information indicating a country to which a target company belongs.

Note that, in FIG. 5A, the industrial classification is shown in the form of text. Alternatively, the information indicating the industrial classification may be represented by industrial classification codes. For example, if the industrial classification codes are of the Japan Standard Industrial Classification, a code “231” is assigned to the nonferrous-metal primary smelting and refining industry, and a code “2813” is assigned to the semiconductor device manufacturing industry. Note that the industrial classification shall not be limited to the Japan Standard Industrial Classification. For example, the industrial classification may be another classification such as the International Standard Industry Classification, or the North American Industry Classification System (NAICS). Moreover, as the industrial classification codes, various codes can be used for classification of industries. Hereinafter, for the sake of description, the industrial classification is text indicating a classification name. Note that a classification name in the processing below can be substituted for an industry classification code. Moreover, as illustrated in FIG. 2, the storage unit 120 may store the industrial classification codes 123. The industrial classification codes 123 are information in which, for example, the classification names and the classification codes in the Japan Standard Industrial Classification are associated with each other. The processing unit 110 may perform conversion processing between a classification name and a classification code, in accordance with the industrial classification codes 123.

Moreover, as illustrated in FIG. 5B, the supply chain network obtaining unit 111 obtains information indicating company-to-company transaction, in accordance with the open information. For example, the trading relationship information included in the open information is the information shown in FIG. 5, or information capable of identifying the information shown in FIG. 5B. The information indicating company-to-company transaction is information in which, for example, information identifying a sales source company, information identifying a sales destination company, and information identifying a product to be traded are associated with one another.

In accordance with such information, the supply chain network obtaining unit 111 generates the supply chain network 121 in the form of a directed graph in which the companies are represented by nodes and the trading relationship is represented by links.

FIG. 5C is a graph partially illustrating an example of the supply chain network 121 to be generated in accordance with the trading relationship shown in FIG. 5B. FIG. 5B shows a relationship in which a company Cl sells a product P1 to a company C10. In such a case, the supply chain network obtaining unit 111 provides a link, having a direction from the company Cl to the company C10, between a node representing Cl and a node representing C10. As illustrated in FIG. 5A, the node representing the company Cl is associated with the company name “Cl”, and further with information on such items as an industrial classification, a reputation, and a nationality. The same applies to the node representing the company C10. Moreover, a link directed from Cl to C10 is associated with a trading product P1. Note that the supply chain network obtaining unit 111 may also obtain such information as a transaction volume and a transaction price, in accordance with the open information, and the information may be associated with a link.

Moreover, FIG. 5B shows a relationship in which the company C10 sells a product P2 to a company C5. In such a case, the supply chain network obtaining unit 111 provides a link, having a direction from the company C10 to the company C5, between the node representing C10 and a node representing C5. Each of the nodes is associated with the information shown in FIG. 5A, and each of the links is associated with the information on, for example, a trading product.

Note that, as described above, in the supply chain network 121; namely, a directed graph, a provider (a seller) of a product of some sort is referred to as “upstream”, and a receiver (a buyer) of a product of some sort is referred to as “downstream”. Note that the same definition of upstream and downstream is also applied to the subnetwork 122 to be described later.

Here, the supply chain network 121 is, in a narrow sense of the term, a network including nodes corresponding to all the companies included in the open information to be processed. Hence, the supply chain network 121 may be a network including a significantly large number of nodes, and the number of nodes may be approximately several thousands or more. Note that the configuration of the supply chain network 121 may be modified in various manners. For example, some companies included in the open information may be deleted.

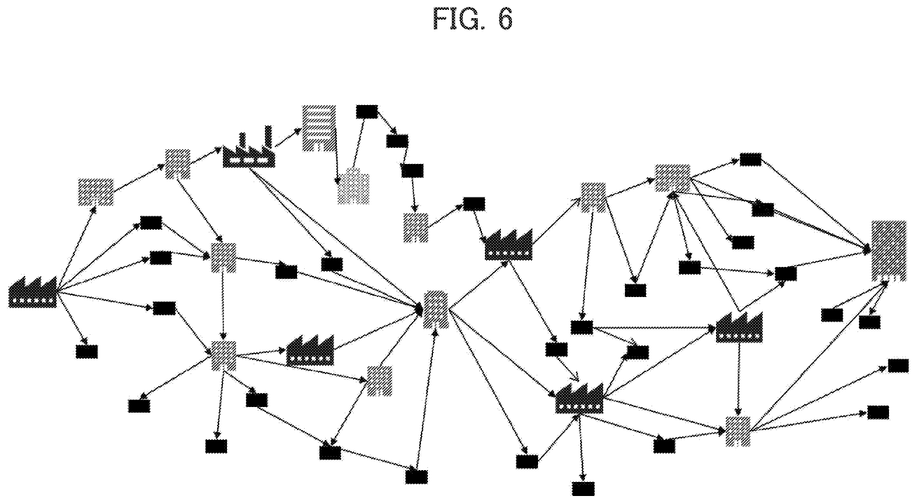

FIG. 6 is a graph schematically illustrating the supply chain network 121. As illustrated in FIG. 6, the supply chain network 121 is a directed graph in which a plurality of nodes are connected together with links representing trading relationships. Note that, in FIG. 6, for the sake of illustration, the nodes are presented in different shapes, depending on whether the nodes represent manufacturing plants or distribution hubs. As described above, the information obtained includes the names and the industrial classifications of the companies corresponding to the respective nodes. Hence, the display mode of the supply chain network 121 can be changed depending on, for example, the industrial classifications. Note that, as to the technique in this embodiment, it is not essential to control the shapes of the nodes.

Note that FIGS. 5A and 5B show an example of a data structure for the supply chain network, and a specific data structure shall not be limited to this example. For example, FIGS. 5A and 5B show a table data structure such as a relational data base. Alternatively, another data structure may be used. Moreover, even if a table data structure is used, the number of the tables shall not be limited to two. The tables may be managed in the form of either one combined table, or of three or more separated tables. Furthermore, some of the items shown in FIGS. 5A and 5B may be omitted, or another item may be added. For example, the supply chain network obtaining unit 111 may obtain information on company names, industrial classification codes, and buy-sell directions, and may omit other information.

### 2.3 Extracting Subnetwork

As to the analysis of a supply chain, it is important to focus on a predetermined first company and analyze a network related to the first company. However, the supply chain network 121 is a network obtained in accordance with, for example, the open information, and includes many nodes and links. Hence, the supply chain network 121 could include nodes and links unrelated to the first company.

In this embodiment, as shown at Step S102 in FIG. 4, the input receiving unit 114 receives a selection operation carried out by the user to select the first company. In this processing, for example, the user trying to carry out the analysis may input a specific company name. Alternatively, the input receiving unit 114 may perform processing to present candidates for the first company. The processing involves receiving information on such items as industrial classifications and products, and performing search processing using these items as search keys. The user selects the first company from the presented candidates, and the input receiving unit 114 receives a selection input.

In accordance with the operation input received by the input receiving unit 114, the subnetwork extracting unit 112 performs processing to extract from the supply chain network 121 the subnetwork 122 related to the first company.

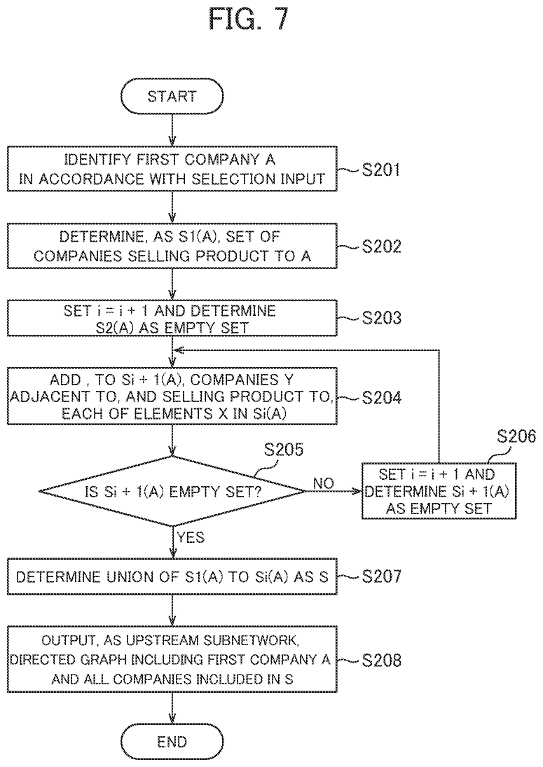

FIG. 7 is a flowchart showing subnetwork extracting processing corresponding to Step S103 in FIG. 4.

At Step S201, the subnetwork extracting unit 112 identifies the first company in accordance with the selection input received by the input receiving unit 114. For example, if the company name of the first company is obtained, the subnetwork extracting unit 112 performs processing to identify the first company in accordance with processing to compare the company name of the first company with a company name associated with each of the nodes in the supply chain network 121.

At Step S202, the subnetwork extracting unit 112 selects all of the companies X adjacent to the first company A and selling something to the first company, and determines a set of the selected companies X as S1(A).

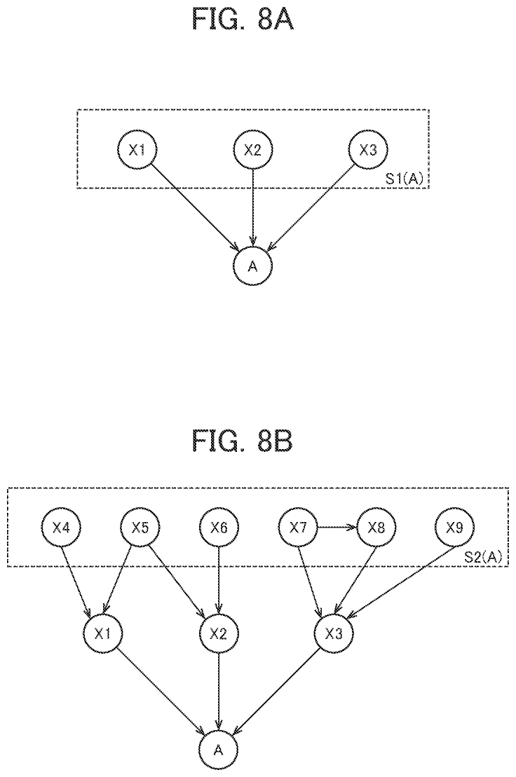

FIG. 8A is an exemplary graph of S1(A). For example, FIG. 8(A) is a graph partially extracted from the supply chain network 121. The extracted graph includes the first company A. In the example of FIG. 8A, a node representing a company X1 is directly connected to a node representing the first company A with a link directed from X1 to A. That is, X1 is a company adjacent to the first company and selling something to the first company. Hence, X1 is determined as an element of S1(A). Likewise, X2 and X3 are also companies adjacent to the first company and selling something to the first company. Hence, X2 and X3 are determined as elements of S1(A). In this case, S1(A) is a set including three elements X1, X2, and X3.

At Step S203, the subnetwork extracting unit 112 initializes a search variable i to 1, and determines Si+1(A) as an empty set. Here, i is initialized to 1, and Si+1 is S2(A). Hence, here, the subnetwork extracting unit 112 determines S2(A) as an empty set.

At Step S204, in relation to each of the elements X in Si(A), the subnetwork extracting unit 112 adds, to Si+1(A), all of the companies Y adjacent to, and selling a product to, the element X. If the processing at Step S204 is performed for the first time to a given first company, i=1 holds. Hence, in this case, in relation to each of the elements X in S1(A), the subnetwork extracting unit 112 adds, to S2(A), all of the companies Y adjacent to, and selling a product to, the element X.

FIG. 8B is an exemplary graph of S2(A). In this example, as described with reference to FIG. 8A, S1(A) is a set including the three elements X1, X2, and X3. The subnetwork extracting unit 112 first identifies a company Y adjacent to, and selling a product to, X1. Here, two elements X4 and X5 satisfy the condition. These two companies are added to S2(A). Next, the subnetwork extracting unit 112 identifies a company Y adjacent to, and selling a product to, X2. Here, two elements X5 and X6 satisfy the condition. Because X5 has already been added to S2(A), X6 is added to S2(A). Next, the subnetwork extracting unit 112 identifies a company Y adjacent to, and selling a product to, X3. Here, three elements X7, X8, and X9 satisfy the condition, and these three companies are added to S2(A). As a result, at Step S204, as illustrated in FIG. 8B, for example, a set including six elements X4, X5, X6, X7, X8, and X9 is generated as S2(A).

At Step S205, the subnetwork extracting unit 112 determines whether Si+1(A) is an empty set. In the example of FIG. 8B, S2(A) includes six elements, and the subnetwork extracting unit 112 determines that Si+1(A) is not an empty set (Step S205: NO). In such a case, at Step S206, the subnetwork extracting unit 112 increments the variable i to initialize Si+1(A) to an empty set. Then, the processing returns to Step S204. Hence, when the processing at Step S204 is executed next time, Si+1(A) is initialized to an empty set.

For example, the subnetwork extracting unit 112 identifies a company Y adjacent to each of the elements X and selling a product to the element X. The subnetwork extracting unit 112 adds the company Y to S3(A). For example, at Step S206, the subnetwork extracting unit 112 initializes S3(A) to an empty set. After that, the subnetwork extracting unit 112 identifies a company adjacent to, and selling a product to, X4, and adds the identified company to S3(A). The same applies to X5 to X9. The subnetwork extracting unit 112 adds, to S3(A), a company adjacent to each of the companies and selling a product to the company.

If S3(A) is not an empty set, the processing returns to Step S204 again, and processing to obtain S4(A) is executed. The succeeding processing is executed in a similar manner. Until Si+1(A) becomes an empty set, the processing from Steps S204 to S206 is repeated.

At Step S205, when Si+1(A) is an empty set, it means that there is no element whose condition is satisfied by the processing at Step S204. That is, none of the companies X; that is, none of the elements of Si(A), has any more upstream company.

Hence, in such a case, at Step S207, the subnetwork extracting unit 112 determines that a union of S1(A), S2(A), Si(A) is S.

At Step S208, the subnetwork extracting unit 112 outputs, as a subnetwork, a directed graph including the first company and nodes corresponding to all the companies included in S. This subnetwork represents upstream companies with reference to the first company, and the subnetwork is also referred to as an upstream subnetwork.

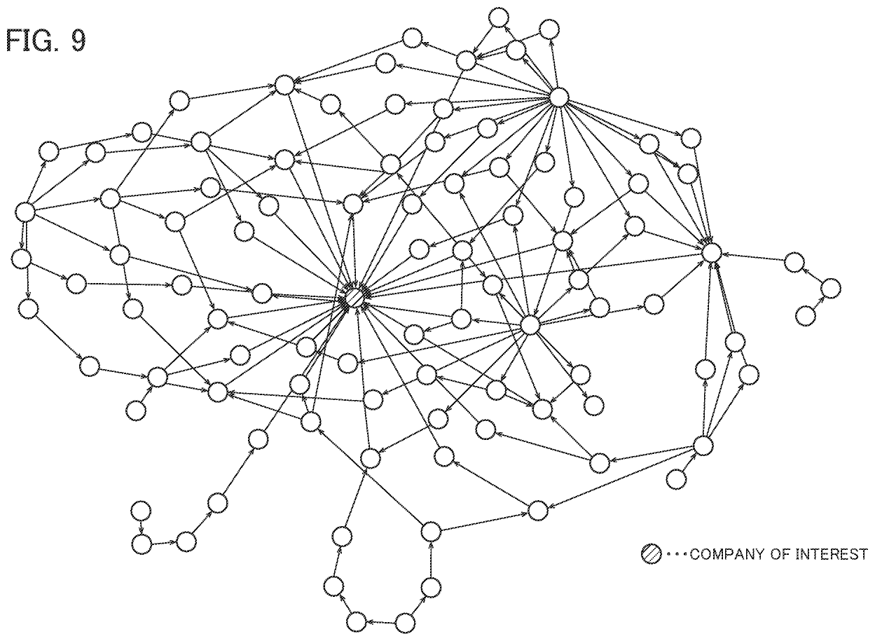

FIG. 9 is a graph illustrating an example of the upstream subnetwork. As illustrated in FIG. 9, the upstream subnetwork is a directed graph including nodes representing companies directly or indirectly connected to the first company. Such a feature makes it possible to appropriately extract a portion included in the supply chain network 121 and related to the first company. The upstream subnetwork is information that allows identification of a company included in a supply chain of the first company and of a specific connection relationship between each of the companies and the first company. Hence, the upstream subnetwork is useful information for analyzing the supply chain of the first company.

Note that, at Step S204, when Si+1(A) is obtained, the subnetwork extracting unit 112 may identify the company Y in accordance with a condition, “the company Y is not included in a union of {A}, S1(A), . . . , and Si(A)”, in addition to the condition, “the company Y is adjacent to, and sells something to, the element X of Si(A)”.

For example, consider a case in which three companies Xa, Xb, and Xc exhibit a cycle of Xa←Xb←Xc←Xa where Xa is an element of Si−2(A), Xb is an element of Si−1(A), and Xc is an element of Si(A). The link “Xa←Xb” shows that Xb is adjacent to, and sells something to, Xa. In such a case, even though Xa is already an element of Si−2(A), Xa can be an element of Si+1(A) because Xa is adjacent to, and sells something to, Xc. That is, when the cycle is also considered, the processing performed by the subnetwork extracting unit 112 would be complex. Whereas, when the above condition “the company Y is not included in a union of {A}, S1(A), . . . , and Si(A)” is added, the company Xa is excluded from the elements of Si+1(A). Such a feature makes it possible to simplify the processing.

Note that the above case describes the upstream subnetwork including the upstream companies with reference to the first company. However, the subnetwork shall not be limited to an upstream subnetwork. The subnetwork may include a downstream subnetwork.

### 2.4 Extracting Path Group

Described below is processing to extract a path group, which corresponds to Step S105 in FIG. 4. The path extracting unit 113 extracts a path group. The path group includes one or more paths connecting a node representing the first company and a node representing the second company with one or more links.

For example, suppose the subnetwork 122 extracted by the subnetwork extracting unit 112 is an upstream subnetwork. In such a case, a company upstream of the first company is selected as the second company. The path extracting unit 113 extracts, from, for example, the subnetwork 122 illustrated in FIG. 9, a path from a node representing the second company to a node representing the first company connected with one or more links.

In this embodiment, here, the path extracting unit 113 extracts a path group including the shortest path as a specific condition. For example, the path extracting unit 113 first extracts all the paths connecting the node representing the second company and the node representing the first company with one or more links. For each of the extracted paths, the path extracting unit 113 calculates the number of links included in the path. The path extracting unit 113 extracts one or more of the paths having the fewest links, and determines the extracted path or paths as the path group. Hence, the path extracting unit 113 can extract a path group including one of more paths. The extracted path group is displayed by the processing at Step S106 on, for example, the display unit 240.

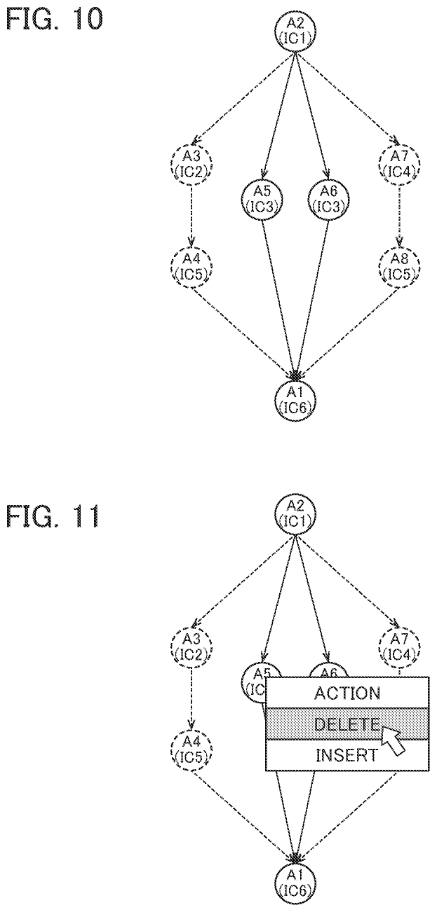

FIG. 10 is a graph schematically illustrating how to extract a path group. The example in FIG. 10 shows processing performed by the path extracting unit 113 to extract a path group. In FIG. each of the nodes denotes a company. For example, the node “A1” denotes a company A1. Moreover, in FIG. 10, each of the nodes is provided with an industrial classification in parentheses. For example, when the node representing the company A1 is provided with an industrial classification IC6, the sign “(IC6)” is assigned to the node. The same notational system is applied to other graphs including nodes. Note that some graphs may omit the notation of an industrial classification.

FIG. 10 shows all the paths from a node representing a second company A2 to the node representing the first company A1 connected with one or more links. That is, in this example, there are four paths from the node representing the first company A1 to the node representing the second company A2. Specifically, a first path is a path that tracks the nodes A2, A3, A4, and A1 in the stated order. A second path is a path that tracks the nodes A2, A5, and A1 in the stated order. A third path is a path that tracks the nodes A2, A6, and A1 in the stated order. A fourth path is a path that tracks the nodes A2, A7, A8, and A1 in the stated order. Note that, in this Specification, hereinafter, “the node representing the company A” is also referred to as “the node A”.

From among these four paths, the path extracting unit 113 extracts a path satisfying a specific condition; that is, the shortest path. The shortest path can be determined in accordance with the number of links that each of the paths has. For example, the first path has three links, the second path has two links, the third path has two links, and the fourth path has three links. Hence, the paths having the fewest links are the second path and the third path each having two links. Thus, in this example, the path extracting unit 113 extracts the second path and the third path as a path group.

The path group extracted in this manner is displayed by the processing at Step S106 on, for example, the display unit 240. In this example, only the second path that tracks the nodes A2, A5, and A1 in the stated order and the third path that tracks the nodes A2, A6, and A1 in the stated order are displayed on the display unit 240.

Note that, in FIG. 10, the paths to be extracted and displayed on the display unit 240 have the links and the nodes represented by solid lines. Whereas, there are paths included in the subnetwork 122 but not extracted because, for example, the paths do not satisfy a specific condition, and thus are not displayed on the display unit 240. Such paths have links and nodes represented by broken lines. In the drawings, hereinafter, the paths are represented in a similar manner so that the links and the nodes to be displayed are distinguished from the links and the nodes not to be displayed.

Note that described here is a case where the shortest paths are determined in accordance with the number of the links. Alternatively, the shortest paths may be determined in accordance with the number of the nodes included in each path.

### 2.5 Deleting Processing

Described below is deleting processing included in the path group redrawing processing corresponding to Step S108 in FIG. 4. The delete processing unit 161 of the redrawing unit 116 executes the deleting processing when the input receiving unit 114 receives an operation input for executing the delete processing.

The operation input for executing the delete processing is, for example, an operation input to delete a specific node included in a path group extracted by the path extracting unit 113. For example, suppose the path extracting unit 113 extracts the path group illustrated in FIG. 10. In this case, as described above, only the second path that tracks the nodes A2, A5, and A1 in the stated order and the third path that tracks the nodes A2, A6, and A1 in the stated order are displayed on the display unit 240. If the user desires to delete a specific node from the nodes displayed on the display unit 240, he or she carries out the operation input to delete the specific node. Hence, the operation input to delete a specific node corresponds to an operation input to execute the delete processing in this embodiment. If the user thinks that, for example, a node representing a specific company cannot possibly be actually found among the nodes presented in the supply chain, he or she carries out the operation input to delete the node representing the specific company.

FIG. 11 is a graph schematically illustrating the operation input to delete a specific node. Here, as an example, the user desires to delete a node representing the company A5. In such a case, the user carries out an input for predetermined processing to be performed on the node A5. For example, the user moves a cursor onto the node A5 displayed on the display unit 240, and clicks the mouse. Then, as illustrated in FIG. 11, for example, a command is displayed to delete the node A5. When the user carries out an operation input to select the command to delete the node A5, the input receiving unit 114 receives the operation input.

When the input receiving unit 114 receives the operation input to delete a specific node (here, the node A5), the delete processing unit 161 of the redrawing unit 116 executes the deleting processing. Specifically, the delete processing unit 161 redraws a path group in the subnetwork. The path group includes a path: connecting the node representing the first company A1 and the node representing the second company A2 with one or more links; and not passing through a specific node. Here, similar to the path extracting unit 113, the delete processing unit 161 may perform the redrawing by extracting a path satisfying a specific condition. That is, in this example, the delete processing unit 161 may perform the redrawing by extracting the shortest path; that is, the specific condition.

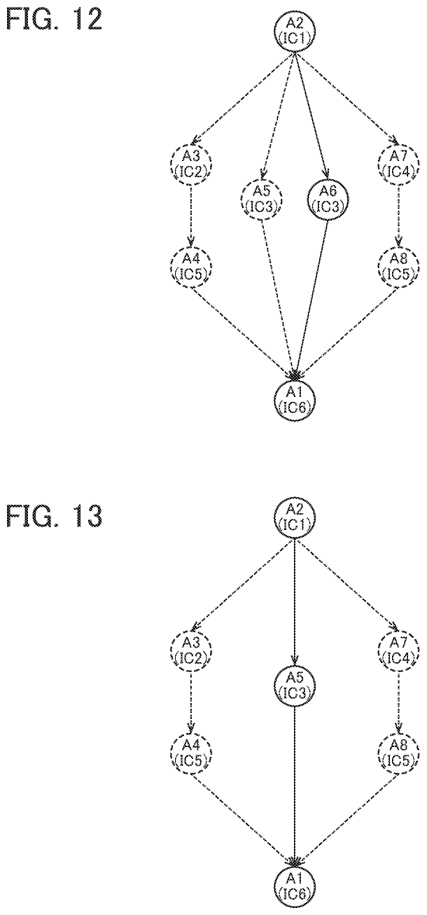

FIG. 12 is a graph schematically illustrating a result of the redrawing in the delete processing. In this example, the shortest path connecting the node A1 and the node A2 with links and not passing through the node A5 is the third path that tracks the nodes A2, A6, and A1 in the stated order. Hence, as illustrated in FIG. 12, the delete processing unit 161 redraws the third path that tracks the nodes A2, A6, and A1 in the stated order. In the redrawing, the second path that tracks the nodes A2, A5, and A1 in the stated order is not extracted. The delete processing unit 161 causes the display unit 240 to display the redrawn path (S109 in FIG. 4). In such a case, as illustrated in FIG. 12, only the third path that tracks the nodes A2, A6, and A1 in the stated order is displayed on the display unit 240.

FIG. 13 is a graph schematically illustrating another example of the delete processing. Specifically, FIG. 13 illustrates another example of the subnetwork 122 extracted by the subnetwork extracting unit 112 and of a path group extracted by the path extracting unit 113. The example in FIG. 13 is the same as the example in FIG. 10 except that no node A6 is found. That is, in the example in FIG. 13, the subnetwork 122 includes: the first path that tracks the nodes A2, A3, A4, and A1 in the stated order; the second path that tracks the nodes A2, A5, and A1 in the stated order; and the fourth path that tracks the nodes A2, A7, A8, and A1 in the stated order. Of these three paths, only the second path; namely, the shortest path, is extracted as a path group, and displayed on the display unit 240.

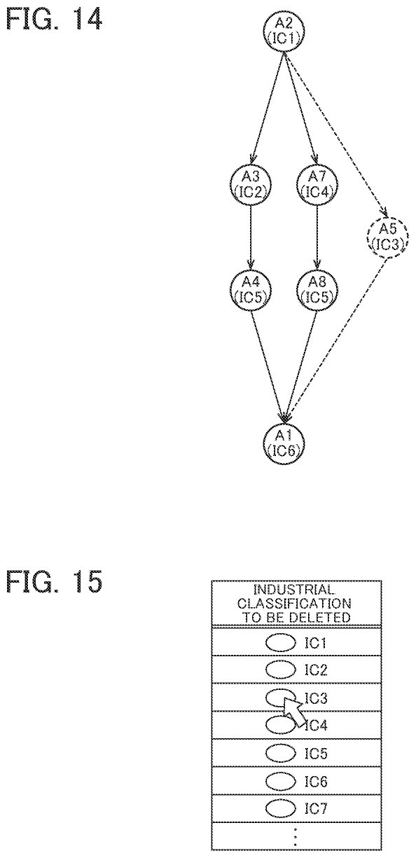

In this case, suppose that the user carries out an operation input to delete the node A5. When the input receiving unit 114 receives an operation input to delete the node A5, the delete processing unit 161 redraws a path group in the subnetwork. The path group includes a path: connecting the node representing the first company A1 and the node representing the second company A2 with one or more links; and not passing through the node A5. In the example in FIG. 13, the first path and the fourth path do not pass through the node A5. Hence, as illustrated in FIG. 14, for example, the delete processing unit 161 redraws the first path that tracks the nodes A2, A3, A4, and A1 in the stated order and the fourth path that tracks the nodes A2, A7, A8, and A1 in the stated order. The redrawn path group including the first path and the fourth path is displayed on the display unit 240.

Note that each of the first path and the fourth path includes three links. However, if either the first path or the fourth path includes four or more links, only the path whichever having fewer links; that is, the shortest path, may be redrawn.

The operation input to execute the delete processing may be performed by, for example, designating an industrial classification. FIG. 15 is a view illustrating an example of an input screen for designating an industrial classification to be deleted. As described above, each node is provided with an industrial classification of the company represented by the node. Here, the industrial classifications are represented as IC1, IC2, IC3, IC4, . . . as illustrated in FIG. 15. For example, as presented in parentheses, the node A1 is provided with an industrial classification IC6, the node A2 is provided with an industrial classification IC1, the node A3 is provided with an industrial classification IC2, the nodes A4 and A8 are provided with an industrial classification IC5, the nodes A5 and A6 are provided with an industrial classification IC3, and the node A7 is provided with an industrial classification IC4.

If the user desires to delete a node that is included in the path group displayed on the display unit 240, and that is provided with a specific industrial classification, he or she carries out an operation input to delete the node provided with the specific industrial classification. The operation input to delete a node provided with a specific node corresponds to an operation input to execute the delete processing in this embodiment. If the user thinks that, for example, a company, represented by a node that is included in the nodes presented in the supply chain and that is provided with a specific industrial classification, cannot possibly be found in the supply chain of the actual trading, he or she carries out the operation input to delete the node provided with the specific industrial classification.

Here, as an example, the user desires to delete a node provided with the industrial classification IC3. In such a case, the user carries out an input operation to display a screen for inputting the industrial classification to be deleted. This operation input presents, for example, radio buttons in FIG. 15 on the display unit 240. The user carries out an operation input with a radio button to select the industrial classification IC3 to be deleted. When the user carries out the operation input to select the industrial classification to be deleted, the input receiving unit 114 receives the operation input. When the input receiving unit 114 receives the operation input, the delete processing unit 161 executes the delete processing. Note that radio buttons are not essential in selecting the industrial classification to be deleted. Any given technique may be used to select the industrial classification to be deleted.

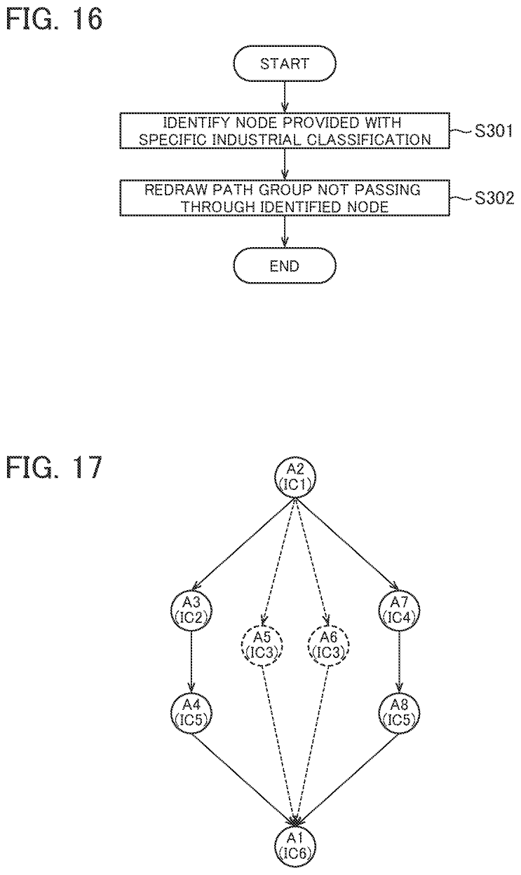

FIG. 16 is a flowchart showing the delete processing executed when a node to be deleted is identified with an industrial classification.

First, at Step S301, the delete processing unit 161 identifies a node included in the subnetwork 122 and provided with the specific industrial classification IC3 selected by the user. In the example in FIG. 10, the delete processing unit 161 identifies the nodes A5 and A6 provided with the specific industrial classification IC3.

Then, at Step S302, the delete processing unit 161 redraws a path group not passing through the nodes identified at Step S301; that is, a path group not passing through either the node A5 or the node A6. The example in FIG. 10 shows that, in the subnetwork 122, the first path that tracks the nodes A2, A3, A4, and A1 in the stated order and the fourth path that tracks the nodes A2, A7, A8, and A1 are redrawn as the path group not passing through either the node A5 or the node A6. Hence, as illustrated in FIG. 17, for example, the path group is redrawn to include the first path and the fourth path. The redrawn path group including the first path and the fourth path is displayed on the display unit 240.

Note that each of the first path and the fourth path includes three links. However, if either the first path or the fourth path includes four or more links, only the path whichever having fewer links; that is, the shortest path, may be redrawn.

Hence, the delete processing involves redrawing a path group not passing through a specific node. The redrawn path group does not present the specific node. Hence, the server system 100 can redraw a path group so that the redrawn path group does not present a node of a company that the user does not desire to be presented in the path group. For example, in accordance with an operation input of the user, the server system 100 can delete from the path group a company not included in the actual supply chain. Such a feature can generate a path group reflecting the actual supply chain more accurately, and display the path group on the display unit 240.

### 2.6 Node Adding Processing

Described below is node adding processing included in the path group redrawing processing corresponding to Step S108 in FIG. 4. The node adding unit 162 of the redrawing unit 116 executes the node adding processing when the input receiving unit 114 receives an operation input for executing the node adding processing. The operation input for executing the node adding processing is to add an additional node to a path group by, for example, connecting a node of a company, which is not included in the path group extracted by the path extracting unit 113, to any one node included in the path group, using a link.

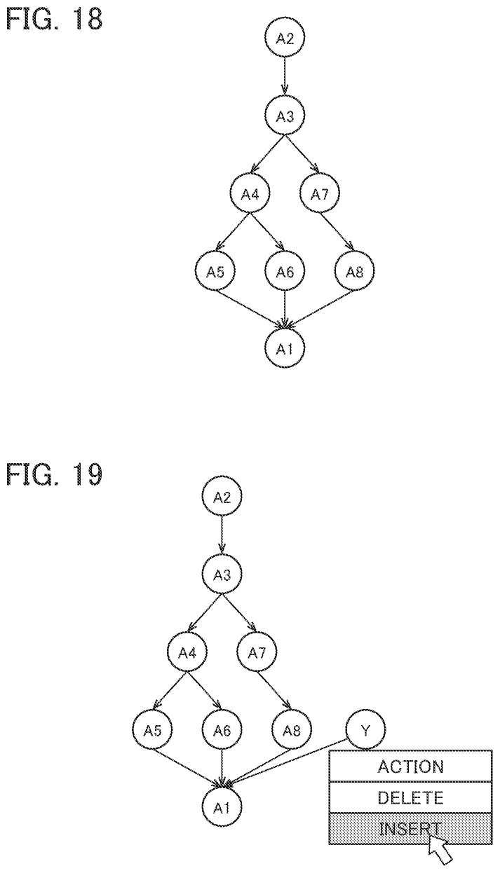

FIG. 18 is a graph schematically illustrating the node adding processing. FIG. 18 illustrates a path group extracted by the path extracting unit 113. The example in FIG. 18 illustrates only a path group extracted as the shortest path from the node A2 to the node A1. The example does not illustrate a path that is not the shortest path even if the path is included in the subnetwork 122. Specifically, FIG. 18 illustrates the fifth path that tracks the nodes A2, A3, A4, A5 and A1 in the stated order; the sixth path that tracks the nodes A2, A3, A4, A6, and A1 in the stated order; and the seventh path that tracks the nodes A2, A3, A7, A8, and A1 in the stated order.

As to this path group, the user desires to add a node representing a company Y to the path group. Moreover, the user knows that the company Y provides (sells) a trading product to the company A1. In such a case, the user carries out an operation input to add the node representing the company Y to the path group. Hence, the operation input to add the new node corresponds to an operation input to execute the node adding processing in this embodiment. For example, if the user cannot find in the path group a company directly trading with his or her company, he or she carries out an operation input to add a node representing the directly trading company. Specifically assumed is a case where the company Y is not found in the original database.

FIG. 19 is a graph schematically illustrating an operation input to add a new node. Here, as an example, the user desires to add a node representing the company Y. In such a case, the user carries out an input to add, to the path group, an additional node Y representing the company Y. For example, the user moves a cursor onto a position in which no node is present in the path group displayed on the display unit 240, and clicks the mouse. Then, as illustrated in FIG. 19, for example, a command is displayed to add an additional node. When the user carries out an operation input to select the command to add the additional node, the input receiving unit 114 receives the operation input. Here, the input receiving unit 114 may receive an input of an industrial classification to be provided to the additional node. In this embodiment, described below is a case where the input receiving unit receives an input of an industrial classification to be provided to the additional node.

Moreover, the user carries out an operation input to select a node, from among the nodes to be included in the path group, to be connected to the additional node Y with a link. Here, as illustrated in FIG. 19, the user carries out an operation input to connect the additional node Y to the node A1 with a link.

When the input receiving unit 114 receives the operation input to add the additional node (here, the node Y), the node adding unit 162 of the redrawing unit 116 executes the node adding processing. Specifically, the node adding unit 162 redraws a path group including the additional node by: extracting candidate nodes that are candidates for a node to be connected to the additional node with a link; and connecting the additional node to any one of the candidate nodes with the link. The node adding unit 162 causes the display unit 240 to display, for example, information on the extracted candidate nodes. For example, the node adding unit 162 causes the display unit 240 to display names of the companies represented by the extracted candidate nodes. The node adding unit 162 connects, with the link, the additional node to a node of a company selected by an operation input of the user from among the companies represented by the candidate nodes displayed on the display unit 240.

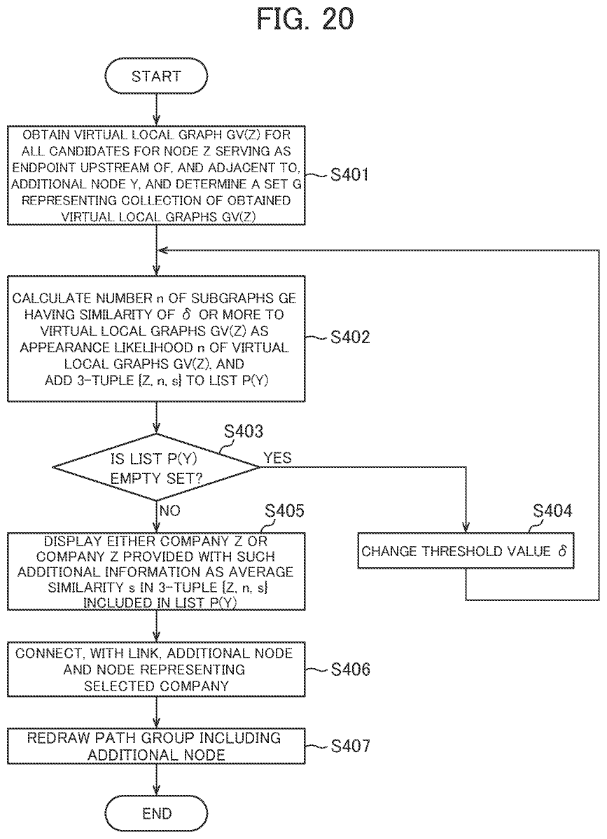

FIG. 20 is a flowchart showing the node adding processing. That is, FIG. 20 is a flowchart showing an example of the node adding processing included in the path group redrawing processing corresponding to Step S108 in FIG. 4. The node adding processing in FIG. 20 is executed when the input receiving unit 114 receives the operation input to add the node Y.

In the flow of FIG. 20, the node adding unit 162 of the redrawing unit 116 calculates appearance likelihood of a virtual local graph GV(Z) in the supply chain network 121. The virtual local graph GV(Z) is formed in the supply chain network 121 when the additional node is connected to one node included in the supply chain network 121. The appearance likelihood is indicated by a predetermined index (a numerical value). For example, the index to indicate the appearance likelihood is frequency of the virtual local graph GV(Z). The appearance likelihood can be calculated in accordance with, for example, the count or the proportion of existing subgraphs similar to the virtual local graph. The existing subgraphs are included in existing subgraphs formed of a portion of the supply chain network. For example, at Steps S401 and S402, the node adding unit 162 calculates the appearance likelihood of the virtual local graph GV(Z) in the supply chain network 121.

Specifically, first, at Step S401, in inserting the additional node Y, the node adding unit 162: obtains a virtual local graph GV(Z) for all the candidates for a node Z serving as an endpoint upstream of, and adjacent to, the additional node Y; and determines a set G representing a collection of the obtained virtual local graphs GV(Z). Here, the virtual local graph GV(Z) is a graph formed of: the additional node Y; the node A1 selected to be connected to the additional node Y; and a local graph G(Z) with respect to a node Z serving as a candidate to be connected to the additional node Y. The local graph G(Z) is a portion of the supply chain network 121. The local graph G(Z) includes: the node Z serving as an endpoint; and a node away to a distance d. Here, d is an integer of 1 or larger. The integer d is counted upstream from the node Z when the local graph G(Z) is directed upstream, and is counted downstream from the node Z when the local graph G(Z) is directed downstream. The virtual local graph GV(Z) is a virtual local graph formed of: the local graph G(Z); the additional node Y; and the node A1 selected to be connected to the additional node Y, all of which are connected with links.

Here, the node Z serving as an endpoint may include either all the nodes included in the supply chain network 121, or a node satisfying a specific condition. The specific condition can be determined as appropriate. For example, the specific condition may be a specific industrial classification to be provided to the node, or a specific location in which a company represented by the node is located. The specific condition may be input by, for example, the user.

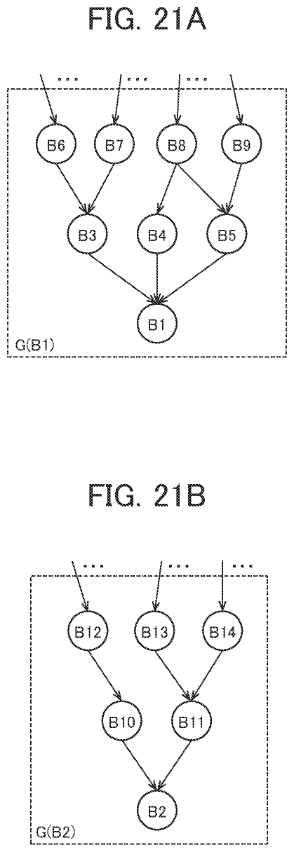

FIGS. 21A and 21B illustrate examples of local graphs. Specifically, FIG. 21A is a graph illustrating an example of a local graph G(B1) including: a node B1 serving as an endpoint; and nodes upstream away to the distance d. FIG. 21B is a graph illustrating an example of a local graph G(B2) including: a node B2 serving as an endpoint; and nodes upstream away to the distance d. Here, the distance d is 2 for both of the local graphs. Both of the local graphs G(B1) and G(B2) are local graphs included in the supply chain network 121. FIG. 21A illustrates a local graph alone having the node B1 serving as the endpoint, and FIG. 21B illustrates a local graph alone having the node B2 serving as the endpoint. However, the nodes serving as the endpoints shall not be limited to the nodes B1 and B2. As described above, the node serving as an endpoint may include either all the nodes included in the supply chain network 121, or a node satisfying a specific condition. In this embodiment, at Step S401, the node adding unit 162 obtains the virtual local graph GV(Z) for all the nodes included in the supply chain network 121.

At Step S402, the node adding unit 162 calculates an appearance likelihood n. Here, the node adding unit 162 calculates the appearance likelihood n, in accordance with the number of existing subgraphs similar to a virtual local graph. Specifically, for all the virtual local graphs GV(Z) included in the set G generated at Step S401, the node adding unit 162 calculates “the number n of existing subgraphs GE found in the supply chain network 121 and having a similarity of δ or more to the virtual local graphs GV(Z)” as “the appearance likelihood n of the virtual local graphs GV(Z) in the supply chain network 121”. Here, the threshold value δ as a predetermined reference may be determined as appropriate in accordance with how to calculate the appearance likelihood. For the n subgraphs GE determined to have a similarity of δ or more to the virtual local graphs GV(Z), the node adding unit 162 obtains an average similarity s of the similarities of the subgraphs GE, and add a 3-tuple {Z, n, s} to a list P(Y). Note that the list P(Y) is previously initialized as an empty set.

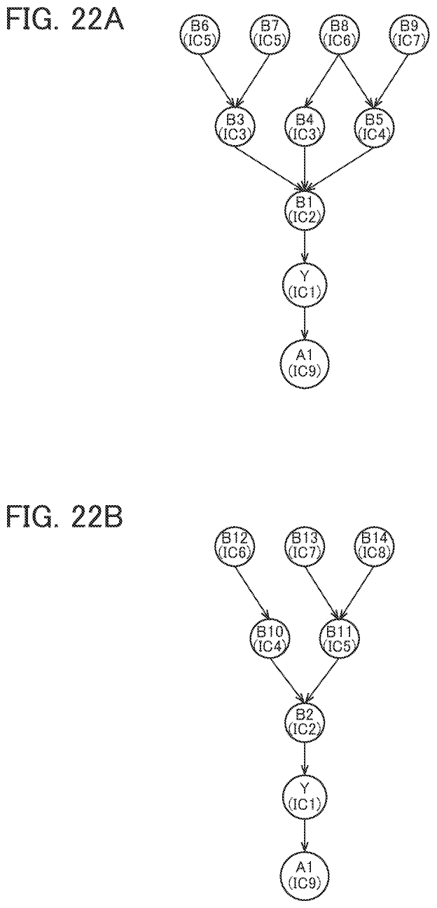

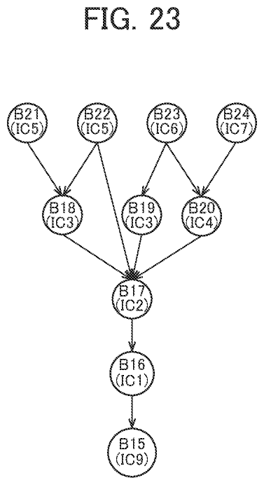

FIGS. 22A and 22B illustrate examples of the virtual local graphs GV(Z). Specifically, FIG. 22A illustrates a virtual local graph GV(B1) including: the local graph G(B1) illustrated in FIG. 21A; the additional node Y; and the node A1 selected to connect to the additional node Y, all of which are connected together with links. FIG. 22B illustrates a virtual local graph GV(B2) including: the local graph G(B2) illustrated in FIG. 21B; the additional node Y; and the node A1 selected to connect to the additional node Y, all of which are connected together with links. As illustrated in FIG. 22A and FIG. 22B, each local graph has the node B1 or the node B2 serving as an endpoint connected to the additional node Y with a link. The additional node Y is connected to the node A1 with a link.

The virtual local graphs GV(Z); that is, the elements of the set G, are likely to appear more frequently in the supply chain network 121 as the appearance likelihood n calculated at Step S402 is larger. Hence, the virtual local graphs GV(Z) are local graphs that are likely to appear in the supply chain network 121. At Step S402, the appearance likelihood n in the supply chain network 121 is the number n of the subgraphs GE included in the supply chain network 121 and having a similarity of δ or more to the virtual local graphs GV(Z). Alternatively, the virtual local graphs GV(Z) may be put in order, using another calculable index.

Moreover, as a technique to compare the likelihood of the two virtual local graphs GV(Z1) and GV(Z2), the average values of the similarities are compared at Step S402 when the appearance likelihood n is the same between the virtual local graphs GV(Z1) and GV(Z2). Alternatively, the maximum values of the similarities may be compared. There are various techniques to compare the likelihoods of the two virtual local graphs, and techniques to compare the likelihoods shall not be limited to the techniques described here.

Here, the similarity between a virtual local graph GV(Z) and an existing subgraph GE in the supply chain network 121 may be determined, using a cosign similarity. A concept as to the use of the cosign similarity as a similarity is described in detail. Described here as an example is a comparison between similarities; that is, a distance between the virtual local graph GV(B1) and the existing subgraph GE and a distance between the virtual local graph GV (B2) and the existing subgraphs GE are calculated, and the proximity between the distances is compared.

At Step S402, the node adding unit 162 extracts one existing subgraph GE included in the supply chain network 121, to compare the extracted existing subgraph GE with a virtual local graph GV(Z). The existing subgraph GE is extracted in accordance with, for example, an industrial classification provided to a node. Specifically, the node adding unit 162: extracts, from the nodes included in the virtual local graph GV(Z), nodes P, Q, and R included in the virtual local graph GV(Z) and having a combination of industrial classifications assigned to the respective node Z serving as an endpoint, additional node Y, and node A1; generates a local graph G(P); and extracts the existing subgraph GE formed of the local graph G(P), the node Q, and the node R connected to one another. For example, if the node Z serving as an endpoint, the additional node Y, and the node A1 are respectively provided with industrial classifications IC2, IC1, and IC9, the industrial classifications of the nodes P, Q, and R in the GE are respectively IC2, IC1, and IC9.

FIG. 23 illustrates an example of the existing subgraph GE included in the supply chain network 121. Here, the nodes B1 and B2 are provided with the industrial classification IC2, the additional node Y is provided with the industrial classification IC1, and the node A1 is provided with the industrial classification IC9. In such a case, the node adding unit 162 extracts, as illustrated in FIG. 23, the existing subgraph GE including nodes B17, B16, and B15; that is, a combination of nodes provided with these industrial classifications IC2, IC1, and IC9.

Then, the node adding unit 162 calculates a similarity between a virtual local graph GV(Z) and the extracted existing subgraph GE. Here, for describing the similarity, an example is given to calculate the similarity between the virtual local graph GV(B1) and the existing subgraph GE and the similarity between the virtual local graph GV(B2) and the existing subgraph GE.

The node adding unit 162, for example, replaces the virtual local graph GV(Z) and the existing subgraph GE with vectors, and calculates a cosign similarity between the vectors. A component of each of the vectors is determined in accordance with, for example, a transition type included in the virtual local graph GV(Z) and in the existing subgraph GE. The transition type is a kind of transition between industrial classifications provided to two nodes connected with a link. For example, if a node provided with the industrial classification IC1 and a node provided with the industrial classification IC2 are connected with a link, a transition type of IC1 to IC2 is found. If two of such transition types are found in either the virtual local graph GV(Z) or the existing subgraph GE, there are “2” components of the vectors representing the transition types.

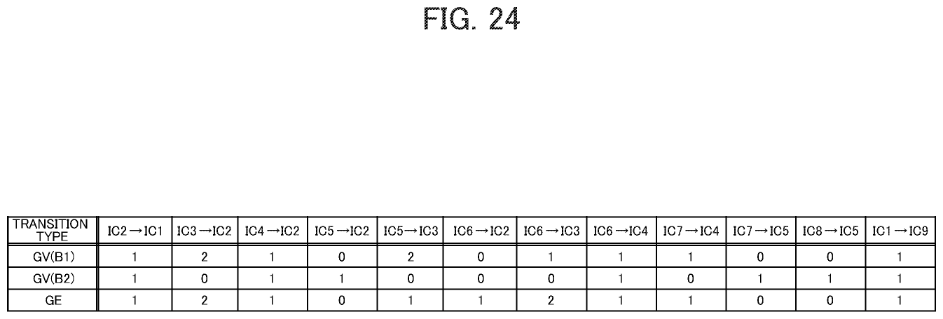

FIG. 24 is a table showing the kinds and number of transition types included in each of the virtual local graph GV(B1), the virtual local graph GV(B2), and the existing subgraph GE. FIG. 24 shows, for example, that a transition type from a node provided with the industrial classification IC1 to a node provided with the industrial classification IC2 is indicated as “IC1→IC2”.

For example, as illustrated in FIG. 22A, the virtual local graph GV(B1) has one transition type from a node provided with the industrial classification IC2 to a node provided with the industrial classification IC1; that is, a transition type from the node B1 to the additional node Y. Hence, in FIG. 24, the box of the transition type “IC1→IC2” for the virtual local graph GV(B1) is indicated by “1”. For example, the virtual local graph GV(B1) has two transition types from a node provided with the industrial classification IC3 to the industrial classification IC2; that is, transition types from the node B3 to the node B1 and from the node B4 to the node B1. Hence, in FIG. 24, the box of the transition type “IC3→IC2” for the virtual local graph GV(B1) is indicated by “2”. As can be seen, the table in FIG. 24 shows kinds and the number of transition types included in the virtual local graph GV(B1), the virtual local graph GV(B2), and the existing subgraph GE. In the table shown in FIG. 24, a kind of a transition type indicates a component of a vector and the number indicated in the kind of the transition type indicates a value of the component of the vector. Hence, in accordance with the table in FIG. 24, for example, the node adding unit 162 can replace the virtual local graph GV(Z) and the existing subgraph GE with vectors. Note that the node adding unit 162 does not necessarily have to create the table in FIG. 24. Alternatively, the node adding unit 162 may convert the virtual local graph GV(Z) and the existing subgraph GE directly into vectors.

The node adding unit 162 calculates a cosign similarity between the virtual local graph GV(Z) and the extracted existing subgraph GE converted into the vectors. The cosign similarity is an index to indicate similarity of two vectors in accordance with an angle formed between the two vectors. The more similar the two vectors are, the closer the value of the cosign similarity is to 1. The less similar the two vectors are, the closer the value of the cosign similarity is to 0. In this example, the cosign similarity between the virtual local graph GV(B1) and the existing subgraph GE is approximately 0.9, and the cosign similarity between the virtual local graph GV(B2) and the existing subgraph GE is approximately 0.4.

If the cosign similarity between the virtual local graph GV(Z) and the existing subgraph GE is a predetermined reference value or greater, the node adding unit 162 determines that one existing subgraph GE similar to the virtual local graph GV(Z) is found. For example, if the reference value is 0.8, the existing subgraph GE illustrated in the example of FIG. 23 is similar to the virtual local graph GV(B1), but not to the virtual local graph GV(B2). Hence, the node adding unit 162 determines that one existing subgraph GE similar to the virtual local graph GV(Z) is found.

As to the virtual local graph GV(Z) selected in accordance with the appearance likelihood n, the node adding unit 162 determines, as a candidate node, one node connected to the additional node Y. If there are a plurality of virtual local graphs GV(Z) selected in accordance with the appearance likelihood n, the node adding unit 162 may determine, as the candidate node, one node connected to the additional node Y in any one of the plurality of virtual local graphs GV(Z). For example, the node adding unit 162 may determine, as the candidate node, a node selected by the user from among the nodes each connected to the additional node Y in the corresponding one of the plurality of local graphs GV(Z). Specifically, the node adding unit 162 may determine the candidate node by the processing at Step S403 to Step S406 in FIG. 20.

Specifically, at Step S403, the node adding unit 162 determines whether the list P(Y) is an empty set. That is, the node adding unit 162 determines whether the list P(Y) records a 3-tuple {Z, n, s} including at least one of a company, an appearance likelihood, or an average similarity.

If the list P(Y) is an empty set; that is, if the list P(Y) does not record any of a company, an appearance likelihood, or an average similarity in the 3-tuple (Step S403: YES), the node adding unit 162 changes the threshold value δ at Step S404. The threshold value δ is changed so that the list P(Y) is not an empty set. Hence, here, for example, the threshold value δ is changed to decrease. The range of change in the threshold value δ may be determined as appropriate, in accordance with such a condition as a technique to calculate a similarity. If the node adding unit 162 changes the threshold value δ at Step S404, the node adding unit 162 moves to Step S402 and executes the processing at Step S402.

If the list P(Y) is not an empty set; that is, if the list P(Y) records at least one of a company, an appearance likelihood, or an average similarity in the-tuple {Z, n, s} (Step S403: NO), the node adding unit 162 causes the display unit 240 to display either the company Z or the company Z provided with such additional information as the average similarity s in the 3-tuple {Z, n, s}. Here, the node adding unit 162 causes the display unit 240 to display the companies Z or the companies Z each provided with such additional information as the average similarity s in descending order of the appearance likelihood n. If the plurality of companies have the same appearance likelihood n, the node adding unit 162 causes the display unit 240 to display the companies in descending order of the average similarity s. That is, the node adding unit 162 causes the display unit 240 to display the companies Z for a candidate node to be connected to the additional node Y with a link.

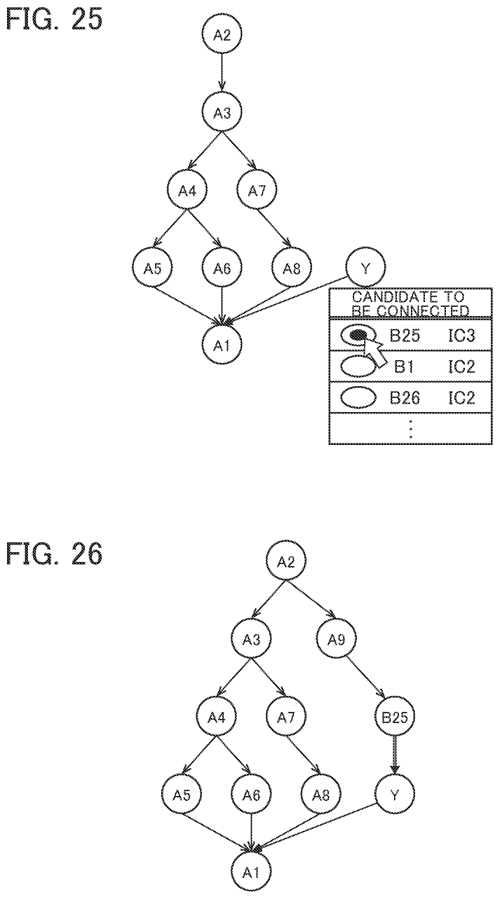

FIG. 25 is a graph illustrating a display example of companies for a candidate node connected to an additional node with a link. As illustrated in FIG. 25, the companies for the candidate node may be displayed in the form of, for example, radio buttons. The companies for the candidate node may be displayed in descending order of, for example, the appearance likelihood n. If the appearance likelihood n is the same, the companies may be displayed in descending order of the average similarity s. Moreover, as illustrated in FIG. 25, each of the companies displayed for the candidate node may be displayed together with an industrial classification to be provided to the candidate node. Furthermore, instead of the appearance likelihood n, the node adding unit 162 may use, as an index, a proportion of the appearance likelihood n to the number of all the nodes, and display the companies Z in descending order of the index. In addition, the node adding unit 162 causes the display unit 240 to display such additional information as the average similarity s together with, or instead of, the companies Z.

The user carries out an operation input to select a company whose node is to be connected to the additional node Y with a link. Here, suppose a company B25 is selected. When the user carries out the operation input for the selection, the input receiving unit 114 receives the operation input. Note that, radio buttons are not essential in selecting the company whose node is to be connected to the additional node Y with a link. Any given technique may be used to select the company whose node is to be connected to the additional node Y with a link.

When the input receiving unit 114 receives the operation input, the node adding unit 162 at Step S406 connects, with a link, the additional node Y and a node representing the selected company B25.

Then, at Step S407, the node adding unit 162 redraws a path group including the additional node Y. Specifically, the node adding unit 162 extracts a path group including a path connecting, with links, the node A2 through the selected node B25 and the additional node Y to the node A1. Here, in accordance with the supply chain network 121, the node adding unit 162 may extract a path connecting the node A2 to the node B25 with links. The node adding unit 162 may extract a path, satisfying a specific condition, from the node A2 to the node B25. For example, the node adding unit 162 extracts the shortest path from the node A2 to the node B25.

FIG. 26 is a graph schematically illustrating a result of redrawing in the node adding processing. As illustrated in FIG. 26, the node A2 through the node B25 are extracted as a path and connected with links. FIG. 26 illustrates an example of the supply chain network 121 in which the node A2 is connected through the node A9 to the node B25 with links. Hence, the nodes A2, A9, and B25 are connected together in the stated order with the links. Moreover, the user selects the node B25, and the selected node B25 is connected to the additional node Y with a link. Furthermore, the user carries out an input operation to connect the additional node Y to the node A1 with a link, and the additional node Y is connected to the node A1 with the link. Hence, as illustrated in, for example, FIG. 26, the node adding unit 162 can generate the result of the redrawing.

The path group redrawn at Step S408 is displayed on the display unit 240 in accordance with the processing executed by the presentation processing unit 115 (Step S109 in FIG. 4).

Note that the presentation processing unit 115 may present a link, connecting the additional node Y and the node of the company selected at Step S406 in FIG. 20, in a different manner from the other links. Here, the node B25 is the node of the company selected at Step S406 in FIG. 20. Hence, as illustrated in, for example, FIG. 26, the presentation processing unit 115 may present the link, connecting the additional node Y and the node B25, in a different manner from the other links. The link may be presented in any given manner as long as the user can recognize the link. In FIG. 26, the link connecting the node B25 and the additional node Y is different from the other links, because the link is indicated by a double-line arrow. Note that the link to connect the node B25 and the additional node Y may be presented in any given manner.

In executing the node adding processing, the user can cause the redrawing unit 116 to redraw a path group including a node not included in the supply chain network 121. Hence, if the user has information on a trading relationship between companies, and the information is not available from, for example, the open information, the node adding processing makes it possible to reflect the information, on the trading relationship, in the path group. Moreover, the node adding processing involves displaying candidate nodes to be connected with a link to an additional node in accordance with similarity, and the user selects, from displayed candidate nodes representing companies, a node to be connected to the additional node. Hence, in redrawing, the redrawing unit 116 draws a path that is expected to highly likely show an actual trading relationship of the company represented by the additional node. Such a feature allows the user to understand in what supply chain the company represented by the additional node is positioned.

Note that, in the example described here, the user connects the additional node Y to the node A1 in the downstream-most position of the path group. However, the user does not necessarily have to connect the additional node Y to the node in the downstream-most position of the path group. The additional node Y may be connected to any node included in the path group.

Moreover, described here is an example of a case where the node adding unit 162 calculates the appearance likelihood in accordance with the number of existing subgraphs similar to a virtual local graph. However, the node adding unit 162 may calculate the appearance likelihood in accordance with the proportion of “the number n of the existing subgraphs GE found in the supply chain network 121 and having a similarity of δ or more to the virtual local graphs GV(Z)” to the number of all the nodes.

### 2.7 Substitute Path Calculating Processing

Described below is substitute path calculating processing included in the path group redrawing processing corresponding to Step S108 in FIG. 4. The substitute path calculating unit 163 of the redrawing unit 116 executes the substitute path calculating processing when the input receiving unit 114 receives an operation input for executing the substitute path calculating processing.

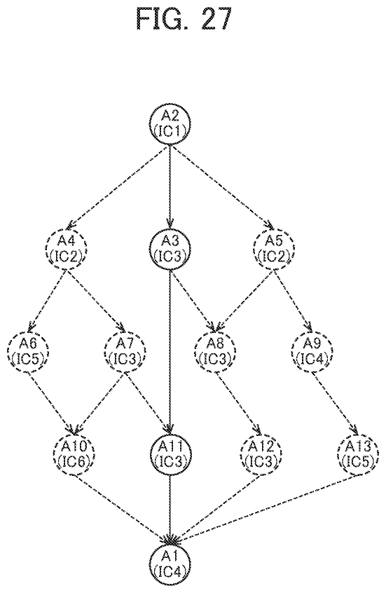

The operation input for executing the substitute path calculating processing is, for example, to calculate a substitute path for a target path connecting an upstream node and a downstream node included in a path group extracted by the path extracting unit 113. The operation input for executing the substitute path calculating processing will be described in detail, with reference to FIG. 27.

FIG. 27 is a graph schematically illustrating the substitute path calculating processing. FIG. 27 illustrates 13 nodes from the node A1 to the node A13. A path group extracted by the path extracting unit 113 and displayed on the display unit 240 includes only a path formed of nodes and links represented by solid lines. That is, in the example in FIG. 27, the path group extracted by the path extracting unit 113 and displayed on the display unit 240 tracks the nodes A2, A3, A11, and A1 in the stated order. The nodes and links represented by broken lines are included in the subnetwork 122; however, such nodes and links do not form, for example, the shortest path as a specific condition. Hence, these nodes and links are not extracted by the path extracting unit 113.

The operation input for executing the substitute path calculating processing includes designation of the target path. The target path is a path included in a path group extracted by the path extracting unit 113. The target path is replaced with the substitute path. The target path is designated when, for example, nodes included in the target path are sequentially designated. For example, in FIG. 27, the nodes A2, A3, A11, and A1 are designated in the stated order, so that a path that tracks the nodes in the order of nodes A2, A3, A11, and A1 is designated as the target path. Note that the nodes may be designated by, for example, a click of a mouse or a touch on a touch panel.

The target path may omit either the upstream-most node or the downstream-most node of, or omit both the upstream-most node and the downstream-most node of, the path group extracted by the path extracting unit 113. The target path may be only a portion of a path (a partial path) included in the path group extracted by the path extracting unit 113. In the example in FIG. 27, the upstream-most node is the node A2 and the downstream-most node is the node A1. Hence, in the example in FIG. 27, the target path may omit either the node A2 or the node A1, or may omit both the node A2 and the node A1. For example, the target path may be a partial path including only the node A3 and the node A11.

The upstream-most node in the target path is referred to an “upstream node” in this Specification. Whereas, the downstream-most node in the target path is referred to a “downstream node” in this Specification. If, as the target path, a path that tracks nodes in the order of the nodes A2, A3, A11, and A1 is designated, the upstream node is the node A2 and the downstream node is the node A1. Whereas if, as the target path, a partial path that tracks nodes in the order of the nodes A3 and A11 is designated, the upstream node is the node A3 and the downstream node is the node A11.

The operation input for executing the substitute path calculating processing may include the designation of the target path, and additionally include the start of the substitute path calculating processing. The operation input for starting the substitute path calculating processing is executed when the designation of the target path ends. The operation input for starting the substitute path calculating processing may be carried out by, for example, an operation using a specific key of the operation unit 250, or an operation using a specific button displayed on the display unit 240.

The operation input for executing the substitute path calculating processing is received by the input receiving unit 114. When the input receiving unit 114 receives the operation input for executing the substitute path calculating processing, the substitute path calculating unit 163 of the redrawing unit 116 executes the substitute path calculating processing. Specifically, the substitute path calculating unit 163 redraws the path group by replacing the designated target path with a substitute path. Here, the substitute path is a path included in the path connecting the upstream node and the downstream node with one or more of the links in the subnetwork 122. The substitute path is different from the target path. The substitute path calculating unit 163 may redrew the path group by replacing the designated target path with one or more substitute paths.

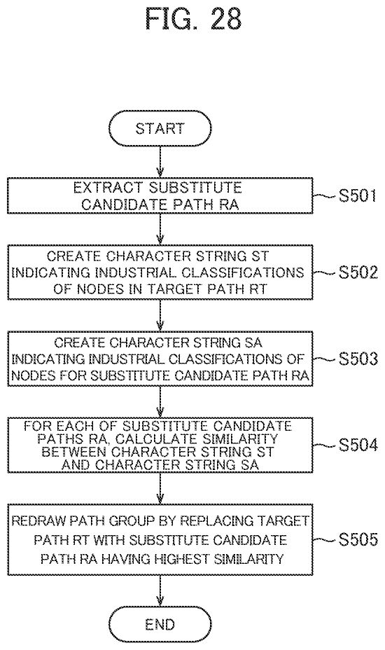

FIG. 28 is a flowchart showing the substitute path calculating processing. With reference to FIG. 28, a specific example of the substitute path calculating processing is described below. Here, in the example illustrated in FIG. 27, a path that tracks nodes in the order of the nodes A2, A3, A11, and A1 is designated as the target path.

First, at Step S501, the path extracting unit 163 extracts a substitute candidate path RA. The substitute candidate path RA is a candidate for the substitute path. The substitute candidate path RA is a path, except a target path RT, connecting the upstream node and the downstream node in the subnetwork 122. The substitute path calculating unit 163 extracts, for example, all the paths included in the subnetwork 122 except the target path RT. The paths connect the upstream node and the downstream node. The substitute path calculating unit 163 may extract only some paths included in the paths of the subnetwork 122 except the target path RT, and connecting the upstream node and the downstream node. The extracted paths may satisfy a specific condition. The specific condition is, for example, the shortest path.

In the example in FIG. 27, the upstream node is the node A2 and the downstream node is the node A1. Hence, the substitute path calculating unit 163 extracts the substitute candidate path RA, except the target path RT, connecting the node A2 and the node A1. Here, the substitute path calculating unit 163 extracts only a substitute candidate path RA as the shortest path. In the example in FIG. 27, the shortest path, except the target path RT, connecting the node A2 and the node A1 includes: a first substitute candidate path that tracks nodes in the order of the nodes A2, A4, A6, A10, and A1; a second substitute candidate path that tracks nodes in the order of the nodes A2, A4, A7, A10, and A1; a third substitute candidate path that tracks nodes in the order of the nodes A2, A5, A8, A12, and A1; and a fourth substitute candidate path that tracks nodes in the order of the nodes A2, A5, A9, A13, and A1. Hence, the path extracting unit 163 extracts these four candidate paths RA.

At Step S502, the substitute path calculating unit 163 creates a character string ST indicating industrial classifications of the nodes in the target path RT. The target path RT is a path that tracks the nodes A2, A3, A11, and A1 in the stated order. The industrial classifications provided to the respective nodes are IC1, IC2, IC3, and IC4. The substitute path calculating unit 163 creates the character string ST indicating these industrial classifications. Here, the substitute path calculating unit 163 may create a character string, translating each of the industrial classifications into one character. For example, when the industrial classifications IC1, IC2, IC3, and IC4 are respectively translated into characters a, b, c, and d, the character string ST of the target path RT is represented as “abcd”.

At Step S503, the substitute path calculating unit 163 creates a character string SA indicating the industrial classifications of the nodes, for a substitute candidate path RA extracted at Step S501. For each of the substitute candidate paths RA extracted at Step S501, the substitute path calculating unit 163 creates the character string SA indicating the industrial classifications of the nodes.

Here, the first substitute candidate path is a path that tracks the nodes A2, A4, A6, A10, and A1 in the stated order. The industrial classifications provided to the respective nodes are IC1, IC2, IC5, IC6 and IC4. The substitute path calculating unit 163 creates a character string SA indicating these industrial classifications. As seen in the character string ST of the target path RT, the substitute path calculating unit 163 may create a character string, translating each of the industrial classifications into one character. Here, a character string SA1 indicates the industrial classifications provided to the first substitute candidate path. For example, when the industrial classifications IC5 and IC6 are respectively translated into characters e and f, the character string SA1 is represented as “abefd”.

The second substitute candidate path is a path that tracks the nodes A2, A4, A7, A10, and A1 in the stated order. The industrial classifications provided to the respective nodes are IC1, IC2, IC3, IC6 and IC4. The substitute path calculating unit 163 creates a character string SA indicating these industrial classifications. A character string SA2 indicates the industrial classifications provided to the second substitute candidate path. The character string SA2 is represented as “abcfd”.

The third substitute candidate path is a path that tracks the nodes A2, A5, A8, A12, and A1 in the stated order. The industrial classifications provided to the respective nodes are IC1, IC2, IC3, IC3 and IC4. The substitute path calculating unit 163 creates a character string SA indicating these industrial classifications. A character string SA3 indicates the industrial classifications provided to the third substitute candidate path. The character string SA3 is represented as “abccd”.

The fourth substitute candidate path is a path that tracks the nodes A2, A5, A9, A13, and A1 in the stated order. The industrial classifications provided to the respective nodes are IC1, IC2, IC4, IC5 and IC4. The substitute path calculating unit 163 creates a character string SA indicating these industrial classifications. A character string SA4 indicates the industrial classifications provided to the fourth substitute candidate path. The character string SA4 is represented as “abded”.

The substitute path calculating unit 163 may determine, as a substitute path, a path included in the extracted substitution candidate paths RA and similar to the target path RT. Then, the substitute path calculating unit 163 may redraw the path group by replacing the target path RT with the substitute path. The substitute path calculating unit 163 may, for example, use the generated character strings ST and SA, and determine at Steps S504 and S505 a substitute candidate path RA most similar to the target path RT from among the plurality of substitute candidate paths RA.

That is, at Step S504, for each of the substitute candidate paths RA, the substitute path calculating unit 163 calculates a similarity between the generated character string SA and the character string ST of the target path RT. The similarity can be calculated by any given known technique. As an example, the substitute path calculating unit 163 can calculate the similarity, using an edit distance (the Levenshtein distance). The edit distance indicates the minimum number of edits required to convert one character string into another character string. The character strings are more similar to each other as the edit distance is shorter. In this example, the substitute path calculating unit 163 calculates an edit distance between the character string ST and each of the character strings SA1, SA2, SA3, and SA4.

At Step S505, the path extracting unit 163 redraws the path group by replacing the target path RT with the substitute candidate path RA having the highest similarity. For example, suppose the edit distance between the character string ST and the character string SA3 is the shortest. That is, suppose the similarity between the target path RT and the third substitute candidate path is the highest. In such a case, the substitute path calculating unit 163 redraws the path group by replacing the target path RT with the third substitute path.

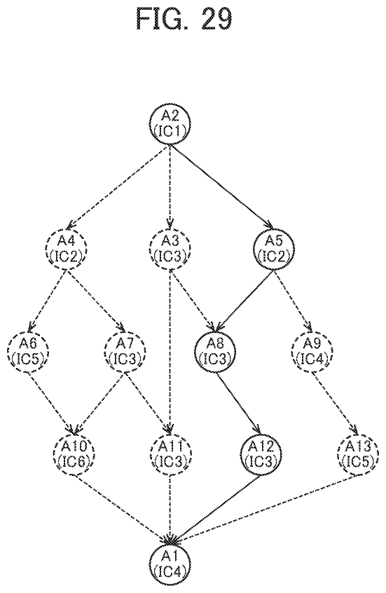

FIG. 29 is a graph schematically illustrating a result of the redrawing in the substitute path calculating processing. FIG. 29 shows that, as the result of the substitute path calculating processing, the target path RT is replaced with the third substitute candidate path that tracks the nodes A2, A5, A8, A12, and A1 in the stated order.

The path group redrawn at Step S505 is displayed on the display unit 240 in accordance with the processing executed by the presentation processing unit 115 (Step S109 in FIG. 4). Here, only the replaced third substitute candidate path may be displayed on the display unit 240. That is, the display unit 240 may display only the nodes and links represented by solid lines in FIG. 29. The target path RT does not have to be displayed on the display unit 240.

Note that the example here describes a case where the substitute path calculating unit 163 determines, as a substitute path, a path included in the extracted substitution candidate paths RA and similar to the target path RT, and replaces the target path RT with the substitute path. However, the substitute path calculating unit 163 does not necessarily have to determine one substitute path. For example, the substitute path calculating unit 163 may replace all the substitute candidate paths RA extracted at Step S501 with the target paths RT. In such a case, the plurality of substitute paths are redrawn and displayed on the display unit 240.

In the substitute path calculating processing, the user can understand a substitute path for the target path RT. Hence, if, for example, a company represented by a specific node in the target path is excluded from the supply chain for some reasons, the user can understand a substitute supply chain. Moreover, as described in this embodiment, if a substitute path similar to the target path is calculated and displayed on the display unit 240, the use can understand a supply chain similar to the target path RT. Hence, assuming a case where, for example, a specific path is not available, the user can easily find out a path to be substituted for the specific path.

### 2.8 Presentation Processing

The presentation processing unit 115 executes presentation processing to present a path group extracted by the path extracting unit 113. The presentation processing unit 115 may present a path group redrawn by the redrawing unit 116. The presentation processing unit 115 can present various kinds of information on the path group. For example, the presentation processing unit 115 can present information on: the names of companies represented by the nodes included in the path group; and the industrial classifications provided to the respective nodes. The presentation processing unit 115 may present, in a comparable manner, a path group before redrawn by the redrawing unit 116 and a path group after redrawn by the redrawing unit 116. For example, the presentation processing unit 115 may present side-by-side a path group before redrawn by the redrawing unit 116 and a path group after redrawn by the redrawing unit 116.

As can be seen, in the information processing system 10 according to the present disclosure, the redrawing unit 116 can redraw a path extracted by the path extracting unit 113. In the example described in the embodiment, the redrawing unit 116 can redraw an extracted path, by executing the delete processing, the node adding processing, or the substitute path calculating processing in accordance with an operation input carried out by the user. Hence, the information processing system 10 can perform more than displaying information. In accordance with an operation input of the user, the information processing system 10 can display information required by the user.

Note that, in the above description of the embodiment, the subnetwork 122 extracted by the subnetwork extracting unit 112 is an upstream subnetwork. However, even if the subnetwork 122 is a downstream subnetwork, the information processing system 10 can execute processing corresponding to the processing, such that the path extracting unit 113 can redraw a path extracted by the path extracting unit 113.

The present embodiment has been discussed so far in detail. A person skilled in the art will readily appreciate that many modifications are possible without substantially departing from the new matter and advantageous effects of the present embodiment. Accordingly, all such modifications are included in the scope of the present disclosure. For example, terms that appear at least once in the Specification or in the drawings along with another broader or synonymous terms can be replaced with the other broader or synonymous terms in any part of the Specification or the drawings. Moreover, all the combinations of the present embodiment and the modifications are encompassed in the scope of the present disclosure. Furthermore, the configurations and operations of the information processing system, the server system, and the terminal device, among others, are not limited to those described in the present embodiment, and various modifications are possible.

While there have been described what are at present considered to be certain embodiments of the invention, it will be understood that various modifications may be made thereto, and it is intended that the appended claim cover all such modifications as fall within the true spirit and scope of the invention.

What is claimed is:

1. An information processing system, comprising:
a supply chain network obtaining unit configured to obtain a supply chain network in which a plurality of nodes, each corresponding to one of a plurality of companies, are connected together with links each representing a trading relationship that associates a supply source company of a product with a supply destination company of the product;
a subnetwork extracting unit configured to extract, from the supply chain network, a subnetwork including at least one of an upstream subnetwork including an upstream company supplying a first company with the product, or a downstream subnetwork including a downstream company supplied with the product from the first company, the upstream company and the downstream company being included in the plurality of companies;
a path extracting unit configured to extract a path group including one or more paths in the subnetwork, the one or more paths connecting a node representing the first company and a node representing a second company with one or more of the links, and the second company being different from the first company; and
a redrawing unit configured to redraw the path group extracted by the path extracting unit.

2. The information processing system according to claim 1, further comprising
an input receiving unit configured to receive an operation input for redrawing of the one or more paths,
wherein the redrawing unit redraws the path group in accordance with the operation input received by the input receiving unit.

3. The information processing system according to claim 2,
wherein the operation input is to delete a specific node included in the path group, and
the redrawing unit redraws a path group, in the subnetwork, including a path: connecting the node representing the first company and the node representing the second company with one or more of the links; and not passing through the specific node.

4. The information processing system according to claim 3,
each of the plurality of nodes is provided with an industrial classification of a corresponding one of the companies of the nodes, and
the specific node is provided with a specific industrial classification input to the input receiving unit.

5. The information processing system according to claim 2,
wherein the operation input is to add an additional node to the path group by connecting a node of a company, which is not included in the path group, to any one of the plurality of nodes included in the path group, using one of the links, and
the redrawing unit redraws the path group including the additional node by: extracting candidate nodes to be possibly connected to the additional node with one of the links; and connecting the additional node to any one of the candidate nodes with the one link.

6. The information processing system according to claim 5,
wherein the redrawing unit:
calculates an index indicating appearance likelihood of a virtual local graph in the supply chain network, the virtual local graph being formed in the supply chain network when the additional node is connected to one of the plurality of nodes included in the supply chain network; and
determines, as the any one candidate node, the one node connected to the additional node in the virtual local graph selected in accordance with the index.

7. The information processing system according to claim 6,
wherein, the redrawing unit calculates the index in the supply chain network in accordance with a count or a proportion of existing subgraphs similar to the virtual local graph, the existing subgraphs being included in existing subgraphs formed of a portion of the supply chain network.

8. The information processing system according to claim 5, further comprising
a presentation processing unit configured to perform processing to present the path group redrawn by the redrawing unit,
wherein the presentation processing unit present a link, connecting any one of the candidate nodes and the additional node, in a different manner from other links, the link and the other links being included in the links.

9. The information processing system according to claim 2,
wherein the operation input is to calculate a substitute path for a target path connecting an upstream node and a downstream node included in the path group, and
the redrawing unit redraws the path group by replacing the target path with the substitute path included in the one or more paths connecting the upstream node and the downstream node with one or more of the links in the subnetwork, the substitute path being different from the target path.

10. The information processing system according to claim 9,
wherein the redrawing unit determines, as the substitute path, a path included in the one or more paths connecting the upstream node and the downstream node with one or more of the links in the subnetwork, the path being similar to the target path.

11. A method for processing information executed by an information processing system, the method comprising:
obtaining a supply chain network in which a plurality of nodes, each corresponding to one of a plurality of companies, are connected together with links each representing a trading relationship that associates a supply source company of a product with a supply destination company of the product;
extracting, from the supply chain network, a subnetwork including at least one of an upstream subnetwork including an upstream company supplying a first company with the product, or a downstream subnetwork including a downstream company supplied with the product from the first company, the first company, the upstream company, and the downstream company being included in the plurality of companies;
extracting a path group including one or more paths in the subnetwork, the one or more paths connecting a node representing the first company and a node representing a second company with one or more of the links, and the second company being different from the first company; and
redrawing the extracted path group.
